(19) United States
(12) Patent Application Publication
(10) Pub. No.: US 2026/0223052 A1
(43) Pub. Date: Jul. 30, 2026

(54) WLAN-BASED POSITIONING SUPPORT FOR LPP

(71) Applicant: QUALCOMM Incorporated, San Diego, CA (US)

(72) Inventors: Alexandros MANOLAKOS, Athens (GR); Xiaoxin ZHANG, Sunnyvale, CA (US); Krishna Kiran MUKKAVILLI, San Diego, CA (US)

(21) Appl. No.: 19/147,667

(22) PCT Filed: Jan. 31, 2024
(86) PCT No.: PCT/US2024/013842

§ 371 Date: Jul. 11, 2025

(30) Foreign Application Priority Data
Feb. 17, 2023 (GR) 20230100140

(51) Int. Cl. H04W 64/00; H04W 84/12

(52) U.S. Cl. CPC H04W 64/00; H04W 84/12

(57) ABSTRACT

A method of wireless communication at a UE is disclosed herein. The method includes obtaining assistance data that indicates at least one WLAN AP supports a first type of WiFi-based positioning, wherein the first type of WiFi-based positioning is associated with at least one of: MIMO, a set of security features, passive positioning, or angle measurement support. The method includes transmitting an indication that the UE supports the first type of WiFi-based positioning. The method includes receiving a request to perform a set of measurements based on the first type of WiFi-based positioning. The method includes performing, based on the request, the set of measurements for the first type of WiFi-based positioning. The method includes outputting an indication of the set of performed measurements for the first type of WiFi-based positioning.

### CROSS-REFERENCE TO RELATED APPLICATION

This application claims the benefit of Greece Patent Application Serial No. 20230100140, entitled “WLAN-BASED POSITIONING SUPPORT FOR LPP” and filed on Feb. 17, 2023, which is expressly incorporated by reference herein in its entirety.

### TECHNICAL FIELD

The present disclosure relates generally to communication systems, and more particularly, to wireless local area network (WLAN) based positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes a memory; and at least one processor coupled to the memory and, based at least in part on information stored in the memory, the at least one processor is configured to obtain assistance data that indicates at least one wireless local-area network (WLAN) access point (AP) supports a first type of WiFi-based positioning, where the first type of WiFi-based positioning is associated with at least one of: multiple input-multiple output (MIMO), a set of security features, passive positioning, or angle measurement support; transmit an indication that the UE supports the first type of WiFi-based positioning; receive a request to perform a set of measurements based on the first type of WiFi-based positioning; perform, based on the request, the set of measurements for the first type of WiFi-based positioning; and output an indication of the set of performed measurements for the first type of WiFi-based positioning.

In an aspect of the disclosure, a method, a computer-readable medium, and an apparatus for wireless communication at a network entity are provided. The apparatus includes a memory; and at least one processor coupled to the memory and, based at least in part on information stored in the memory, the at least one processor is configured to: transmit assistance data that indicates at least one wireless local-area network (WLAN) access point (AP) supports a first type of WiFi-based positioning, where the first type of WiFi-based positioning is associated with at least one of: multiple input-multiple output (MIMO), a set of security features, passive positioning, or angle measurement support; receive an indication that a user equipment (UE) supports the first type of WiFi-based positioning; transmit a request for the UE to perform a set of measurements based on the first type of WiFi-based positioning; and receive an indication of the set of performed measurements for the first type of WiFi-based positioning.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and a user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example of WiFi ranging with a fine timing measurement.

FIG. 8 is a diagram illustrating example features supported by 802.11az based positioning.

FIG. 9 is a diagram illustrating an example of a passive location trigger based sequence.

FIG. 10 is a diagram illustrating example aspects of passive location positioning.

FIG. 11 is a diagram illustrating an example of performing passive location positioning.

FIG. 12 is a diagram illustrating an example of an angle of arrival (AoA) field format.

FIG. 13 is a diagram illustrating example aspects of wireless local area network (WLAN) based positioning.

FIG. 14 is a diagram illustrating example aspects pertaining to WiFi status in a long-term evolution (LTE) positioning protocol (LPP).

FIG. 15 is a diagram illustrating example aspects of WLAN assistance data.

FIG. 16 is a diagram illustrating further aspects of WLAN assistance data.

FIG. 17 is a diagram illustrating example aspects of channels supported by 802.11az protocol.

FIG. 18 is a diagram illustrating example aspects of signaling pertaining to 802.11az protocol.

FIG. 19 is a diagram illustrating further example aspects of signaling pertaining to 802.11az.

FIG. 20 is a diagram illustrating example communications between a UE and a network entity.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a diagram illustrating an example of a hardware implementation for an example apparatus and/or network entity.

FIG. 26 is a diagram illustrating an example of a hardware implementation for an example network entity.

FIG. 27 is a diagram illustrating an example of a hardware implementation for an example network entity.

### DETAILED DESCRIPTION

WiFi-based positioning may enable a location of a UE to be determined based on data/signals transmitted to access points (APs) by the UE and/or data received by the UE from the APs via a wireless local area network (WLAN) protocol. One such protocol may be 802.11-az which includes support for 802.11-az based positioning. 802.11-az based positioning may include support for multiple input-multiple output (MIMO), multiple user multiple input-multiple output (MU-MIMO), angle of departure (AoD) and angle of arrival (AoA) measurements, passive positioning/passive ranging, medium access control (MAC) security, and/or physical (PHY) security. Such features may not be supported by other types of positioning technologies, such as positioning technologies that utilize a fine timing measurement (FTM). Furthermore, some types of long-term evolution positioning protocol (LPP) signaling used for positioning may not include support for the aforementioned features.

Various technologies pertaining to 801.11az based positioning support for LPP are described herein. In an example, a UE obtains assistance data that indicates at least one WLAN AP supports a first type of WiFi-based positioning, where the first type of WiFi-based positioning is associated with at least one of: MIMO, a set of security features, passive positioning, or angle measurement support. The UE transmits an indication that the UE supports the first type of WiFi-based positioning. The UE receives a request to perform a set of measurements based on the first type of WiFi-based positioning. The UE performs, based on the request, the set of measurements for the first type of WiFi-based positioning. The UE outputs an indication of the set of performed measurements for the first type of WiFi-based positioning.

Particular aspects of the subject matter described in this disclosure can be implemented to realize one or more of the following potential advantages. Vis-à-vis the aforementioned technologies, the UE may be informed that the at least one WLAN AP supports the first type of WiFi-based positioning (e.g., 802.11-az based positioning). The UE may then perform the set of measurements using the first type of WiFi-based positioning. Thus, the aforementioned technologies may facilitate a more accurate location determination of the UE in comparison to other types of WiFi-based positioning.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

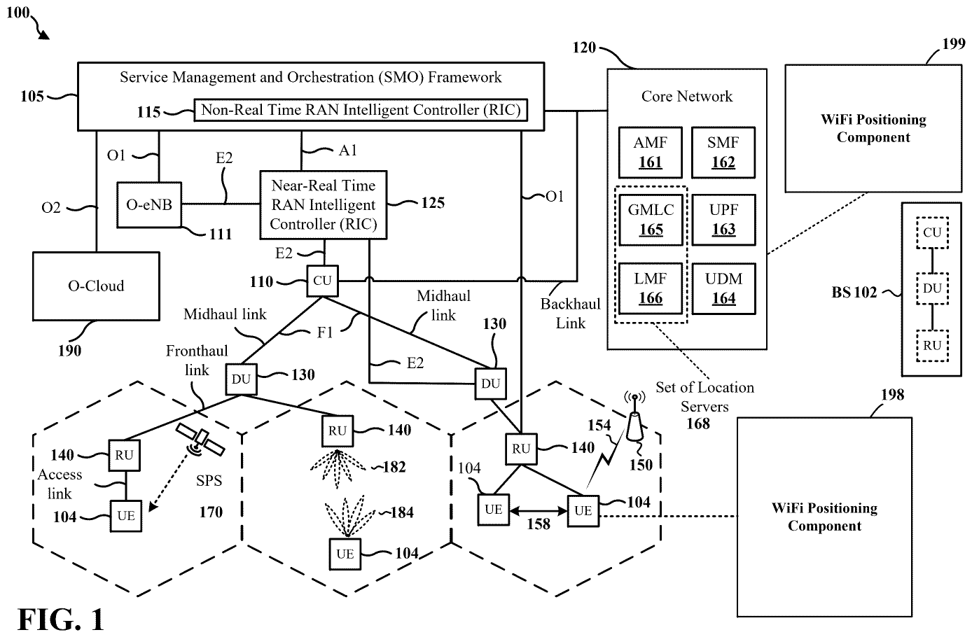

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, WiFi based on the Institute of Electrical and Electronics Engineers (IEEE) 802.11 standard, LTE, or NR.

The wireless communications system may further include a WiFi AP 150 in communication with UEs 104 (also referred to as WiFi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a WiFi positioning component 198 that may be configured to obtain assistance data that indicates at least one WLAN AP supports a first type of WiFi-based positioning, where the first type of WiFi-based positioning is associated with at least one of: MIMO, a set of security features, passive positioning, or angle measurement support; transmit an indication that the UE supports the first type of WiFi-based positioning; receive a request to perform a set of measurements based on the first type of WiFi-based positioning; perform, based on the request, the set of measurements for the first type of WiFi-based positioning; and output an indication of the set of performed measurements for the first type of WiFi-based positioning. In certain aspects, the core network 120 may have a WiFi positioning component 199 that may be configured to transmit assistance data that indicates at least one WLAN AP supports a first type of WiFi-based positioning, where the first type of WiFi-based positioning is associated with at least one of: MIMO, a set of security features, passive positioning, or angle measurement support; receive an indication that a UE supports the first type of WiFi-based positioning; transmit a request for the UE to perform a set of measurements based on the first type of WiFi-based positioning; and receive an indication of the set of performed measurements for the first type of WiFi-based positioning. Although the following description may be focused on 802.11az-based positioning, the concepts described herein may be applicable to other types of WiFi-based positioning as well.

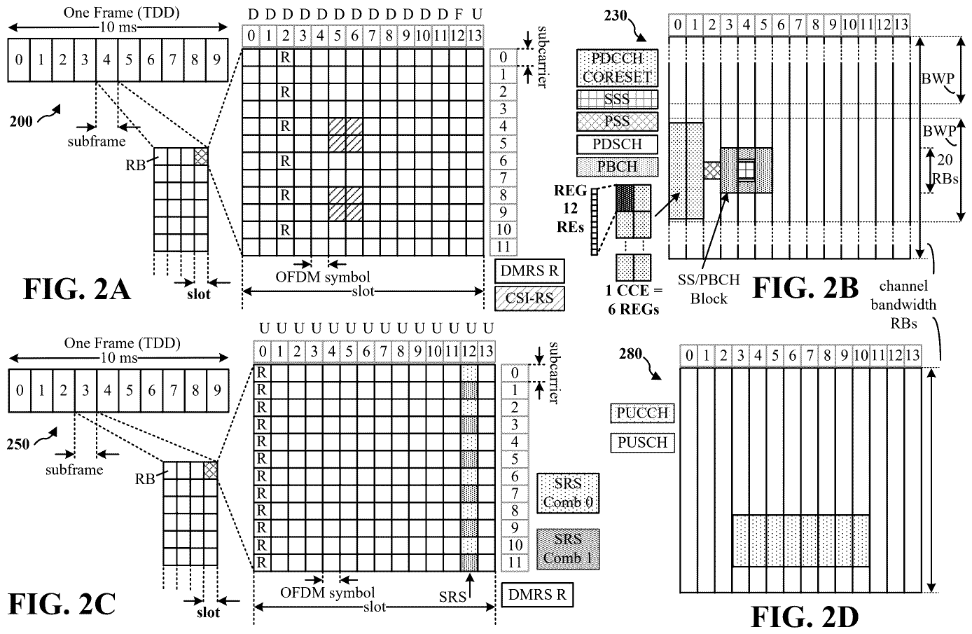

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

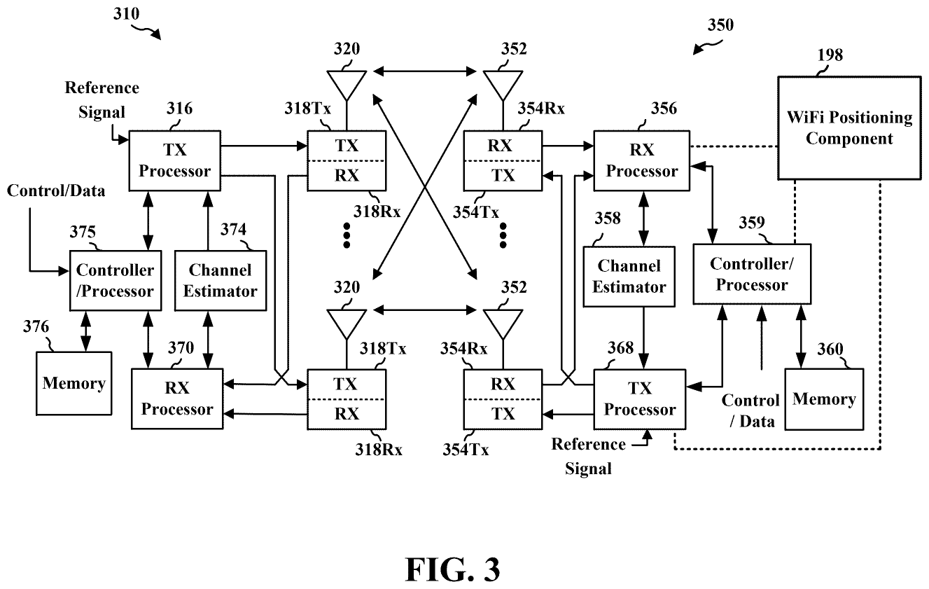

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the WiFi positioning component 198 of FIG. 1.

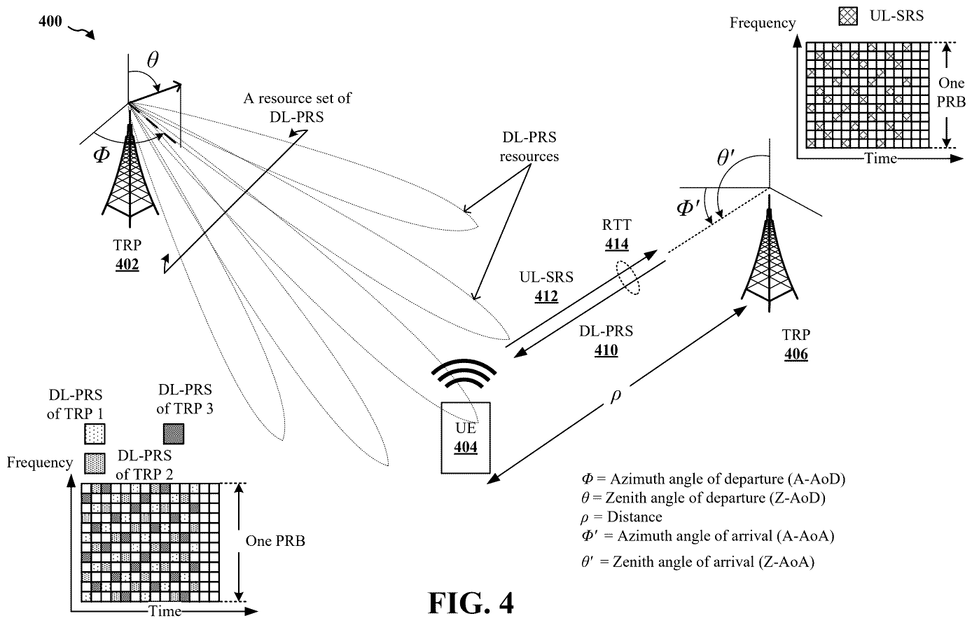

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

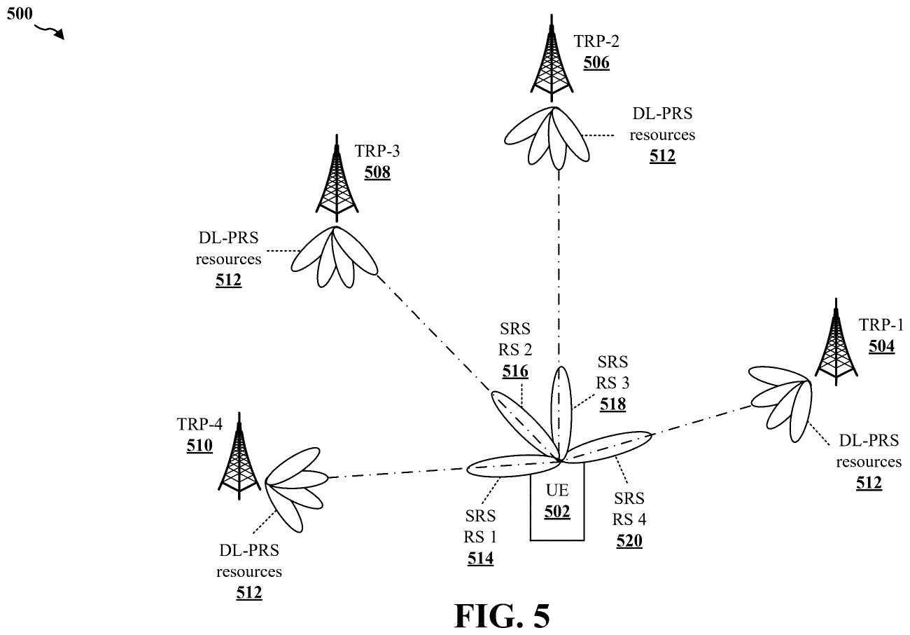

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

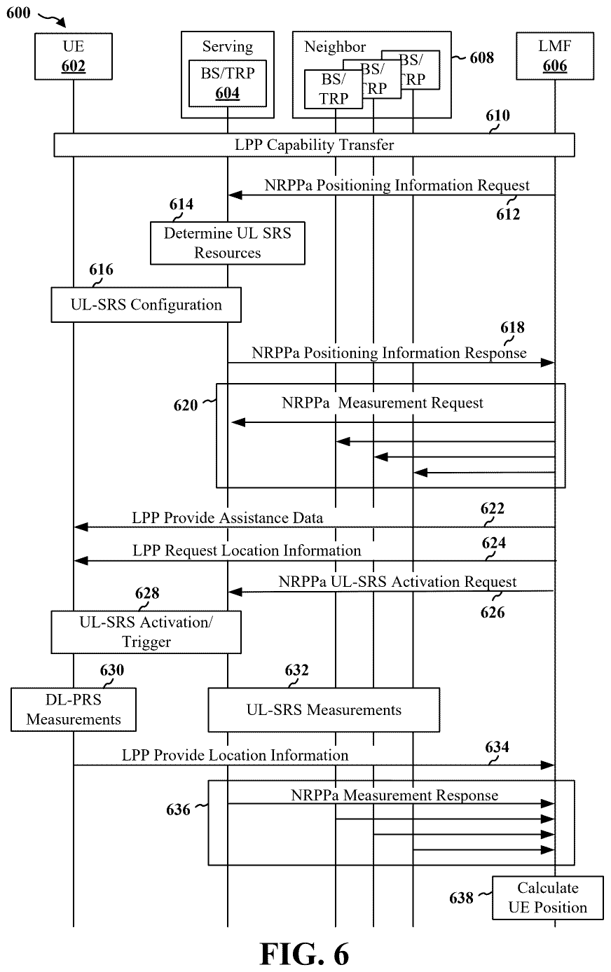

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Some aspects of wireless communication may utilize different types of positioning reference signals (PRSs), such as downlink (DL) PRSs. PRSs are utilized by different wireless communications (e.g., new radio (NR)) and positioning methods in order to enable devices (e.g., UEs) to detect and measure different objects. For example, PRSs may enable UEs to detect and measure an increased about of neighbor TRPs or base stations. Several different types of positioning configurations are supported in wireless communications in order to enable a variety of deployments or environments for the devices or UEs (e.g., indoor environments, outdoor environments, sub-6 environments, mmW environments). Both UE-assisted positioning methods (e.g., calculations) and UE-based position methods are supported by different types of wireless communications (e.g., NR). Further, some types of positioning methods may be supported by specific types of wireless communication (e.g., NR). For instance, NR positioning methods may support at least one of: NR multiple round trip time (multi-RTT) positioning, NR downlink (DL) time difference of arrival (DL-TDOA) positioning, or NR DL angle of departure (DL-AoD) positioning.

In some aspects, different types of reference signals (e.g., downlink (DL) or uplink (UL) reference signals) and UE measurements may be utilized to facilitate the support of different positioning techniques. For example, DL PRSs and DL reference signal time difference (RSTD) UE measurements may facilitate support of DL-TDOA positioning. Also, DL PRSs and DL PRS reference signal received power (RSRP) UE measurements may facilitate support of DL-TDOA positioning, DL-AoD positioning, and/or multi-RTT positioning. Moreover, DL PRSs and sounding reference signals (SRS) for positioning and UE reception (Rx)-transmission (Tx) (Rx-Tx) time difference UE measurements may facilitate support of multi-RTT positioning. Further, synchronization signal blocks (SSBs) and channel state information (CSI)-reference signals (CSI-RSs) for radio resource management (RRM), as well as synchronization signal (SS)-RSRP (e.g., RSRP for RRM), SS-reference signal received quality (SS-RSRQ) (e.g., for RRM), CSI-RSRP (e.g., for RRM), and CSI-RSRP (e.g., for RRM), may facilitate support of enhanced-cell identifier (ID) (E-CID) positioning.

Different aspects of positioning may also utilize preconfigured DL PRS assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area ID. In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID.

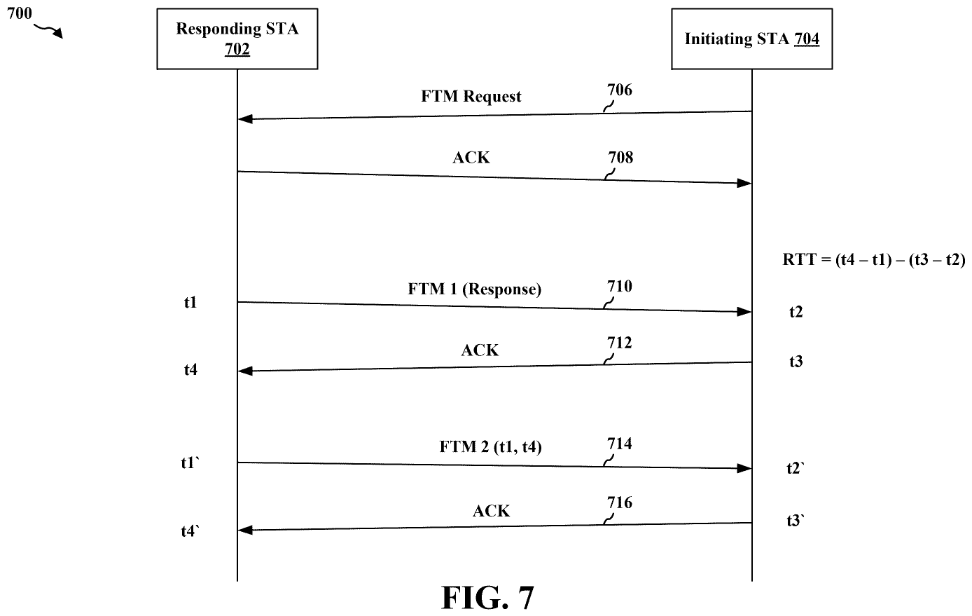

FIG. 7 is a diagram 700 illustrating an example of WiFi ranging with a fine timing measurement (FTM). A FTM protocol may provide a way for two WiFi devices to measure a round-trip time (RTT), access point (AP) network management, etc. The FTM protocol may also be used for AP to station ranging in order to provide indoor range estimation. The FTM protocol may support ranging between AP-to-AP, AP-to-station, and station-to-station. Neighbor awareness networking (NAN) ranging may utilize FTM RTT measurements for peer-to-peer ranging. Ranging may refer to utilizing time-of-flight measurements to estimate a distance between two devices with WiFi capabilities. Ranging may be used for a variety of purposes including indoor navigation, asset tracking, geofencing, access control, and/or device operation. In an example, AP-to-AP ranging may be used for pedestrian navigation, consumer analytics, proximal “push” advertising and content delivery, etc. In another example, peer-to-peer ranging may be used for finding people and items of interest, for digital key vehicle lock/unlock, infectious disease contact tracing, etc.

The diagram 700 depicts a responding station 702 and an initiating station 704. The responding station 702 (which may also be referred to as a “RSTA”) may be a first AP, a first mobile phone, or a first device with WiFi capabilities. The initiating station 704 (which may also be referred to as a “ISTA”) may be a second AP, a second mobile phone, or a second device with WiFi capabilities.

At 706, the initiating station 704 may transmit a FTM request. At 708, the responding station 702 may transmit an acknowledgment (ACK) upon receiving the FTM request. At 710 (time t1), the responding station 702 may transmit a first FTM (a Response) which may be received by the initiating station 704 at time t2. At 712 (time t3), the initiating station 704 may transmit an ACK which may be received by the responding station 702 at time t4. The RTT (i.e., a RTT measurement) may be estimated (e.g., by the responding station 702) according to equation (I) below:

$$R T T = ( t 4 - t 1 ) - ( t 3 - t 2 ) \qquad ( I )$$

The above-described procedure may be repeated. At 714 (time t1′), the responding station 702 may transmit a second FTM (t1, t4) which may be received by the initiating station 704 at time t2′. At 716 (time t3′), the initiating station 704 may transmit an ACK which may be received by the responding station 702 at time t4′. The RTT may be estimated again using equation (I). The responding station 702 may average several RTT measurements in order to determine a position of the responding station 702 and/or the initiating station 704.

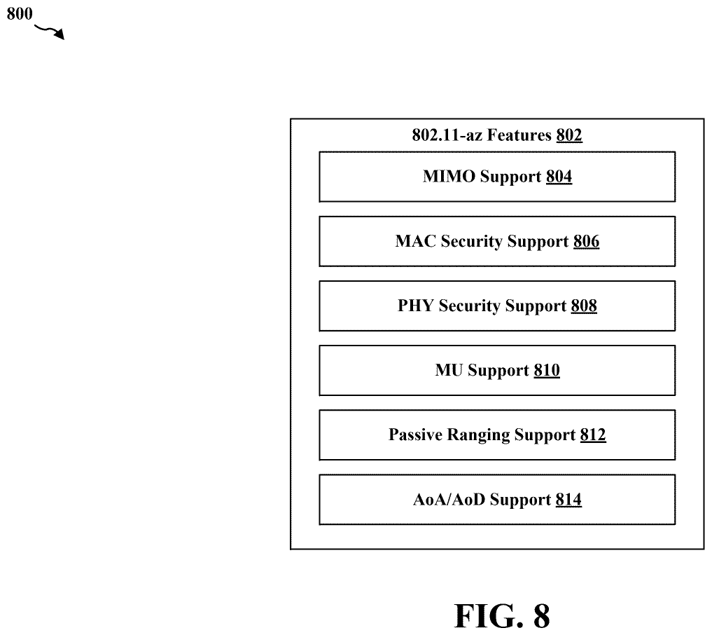

FIG. 8 is a diagram 800 illustrating example features supported by 802.11az based positioning. 802.11 may refer to a technical standard that is part of the Institute of Electrical and Electronics Engineers (IEEE) and that specifies a set of medium access control (MAC) and physical layer (PHY) protocols for implementing wireless local area network (WLAN) computer communications. 802.11az may refer to a specific 802.11 protocol that enables a station to identify its position relative to multiple APs.

The 801.11az protocol may support a set of features (referred to in the diagram 800 as 802.11-az features 802). The 802.11-az features 802 may include MIMO support 804. MIMO support 804 may refer to support for a process for multiplying a capacity of a radio link using multiple transmission and receiving antennas to exploit multipath propagation. MIMO support 804 may include support for null data packet (NDP) based MIMO measurements to improve ranging accuracy and reduce ranging latency.

The 802.11-az features 802 may include MAC security support 806. MAC security support 806 may refer to a set of security features that are implemented at a MAC layer of a device. The MAC security support 806 may be for both associated and unassociated client devices. The MAC security support 806 may be used to encrypt a location measurement report (LMR) and/or an initial FTM request (iFTMR) and initial FTM (iFTM). The 802.11-az features 802 may include PHY security support 808. PHY security support 808 may refer to a set of security features that are implemented at a PHY layer of a device. The PHY security support 808 may be for both associated and unassociated client devices. The PHY security support 808 may utilize a 128-bit advanced encryption standard (AES-128) and zero constraint programming (zero-CP) to prevent a RTT measurement attack. The 802.11-az features 802 may also include pre-association security negotiation (PASN) to provide security for unassociated client devices.

The 802.11-az features 802 may include multiple user (MU) support 810, e.g., MU-MIMO support. MU-MIMO may refer to a technology that enables devices (e.g., a WiFi router) to communicate with multiple devices simultaneously, where each of the devices transmits radio transmissions over one or more antennas. MU-MIMO may leverage multiple devices as spatially distributed transmission resources. In an example, the MU support 810 may include trigger based MU-MIMO to support multiple client devices.

The 802.11-az features 802 may include passive ranging support 812 (explained in greater detail below. Passive ranging support may also be referred to as “passive location support.” Passive ranging may be associated with passive positioning which may support a relatively large number of client devices and may improve scalability. The 802.11-az features 802 may include AoA/AoD support 814. AoA/AoD support 814 may refer to support for performing AoA measurements and/or AoD measurements. In comparison to the 802.11-az features 802, a FTM protocol may support a single stream, may not include MAC security features, may not include PHY security features, may not include MU support, may not support passive ranging, and may not support AoA/AoD measurements.

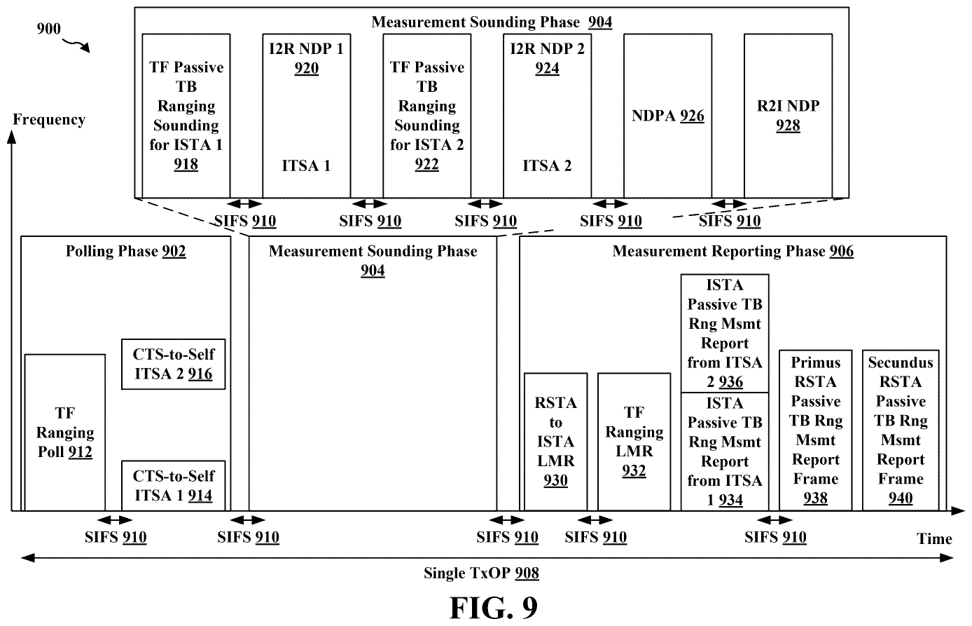

FIG. 9 is a diagram 900 illustrating an example of a passive location trigger-based sequence. In FIG. 9, the acronym “TB” may refer to trigger-based (as opposed to transport block). The passive location TB sequence may be used for passive location positioning (explained in greater detail below). The passive location TB sequence may be similar to a TB ranging sequence. In an example with respect to the diagram 900, a receiving station (RSTA) and an initiating station (ISTA) may be APs and passive stations (PSTAs) may be client stations. The passive location TB sequence may include a polling phase 902, a measurement sounding phase 904, and a measurement reporting phase 906. The polling phase 902, the measurement sounding phase 904, and the measurement reporting phase 906 may be included in a single transmit operation (TxOP) 908. A short interframe space (SIFS) 910 may separate the polling phase 902 from the measurement sounding phase 904 and the measurement sounding phase 904 from the measurement reporting phase 906.

The polling phase 902 may include a trigger frame (TF) ranging poll 912. The TF ranging poll 912 may be a signal transmitted to trigger a ranging procedure. The polling phase 902 may include a clear to send (CTS)-to-self-ITSA 1 914 and a CTS-to-self-ITSA 2 916, where the CTS-to-self-ITSA 1 914 and the CTS-to-self-ITSA 2 916 may be separated by the SIFS 910.

The measurement sounding phase 904 may include a TF passive TB ranging sounding for ISTA 1 918, an initiator-to-responder (I2R) null data packet (NDP) 1 920 for ISTA 1, TF passive TB ranging sounding for ISTA 2 922, an I2R NDP 2 924 for ISTA 2 924, a null data packet announcement (NDPA) 926, and a responder-to-initiator (R2I) NDP 928 each separated by the SIFS 910. ISTAs can measure time of arrivals (ToAs) of I2R NDPs from other ISTAs (e.g., the I2R NDP 1 920 for ISTA 1, the I2R NDP 2 924 for ISTA 2) to improve location measurements for PSTAs. A NDP may refer to a packet that does not contain data.

The measurement reporting phase 906 may include a RSTA to ISTA location measurement report (LMR) 930, a TF ranging LMR 932, a ISTA passive TB ranging measurement report from ITSA 1 934, a ISTA passive TB ranging measurement report from ITSA 2 936, a primus RSTA passive TB ranging measurement report frame 938, and a secundus RSTA passive TB ranging measurement report frame 940. A PSTA may receive the primus RSTA passive TB ranging measurement report frame 938 and the secundus RSTA passive TB ranging measurement report frame 940 in order to facilitate computation of a location of the PSTA. ISTAs may reveal measurements performed by the ISTAs via ISTA LMRs and location configuration information (LCI) information if an update is to be performed.

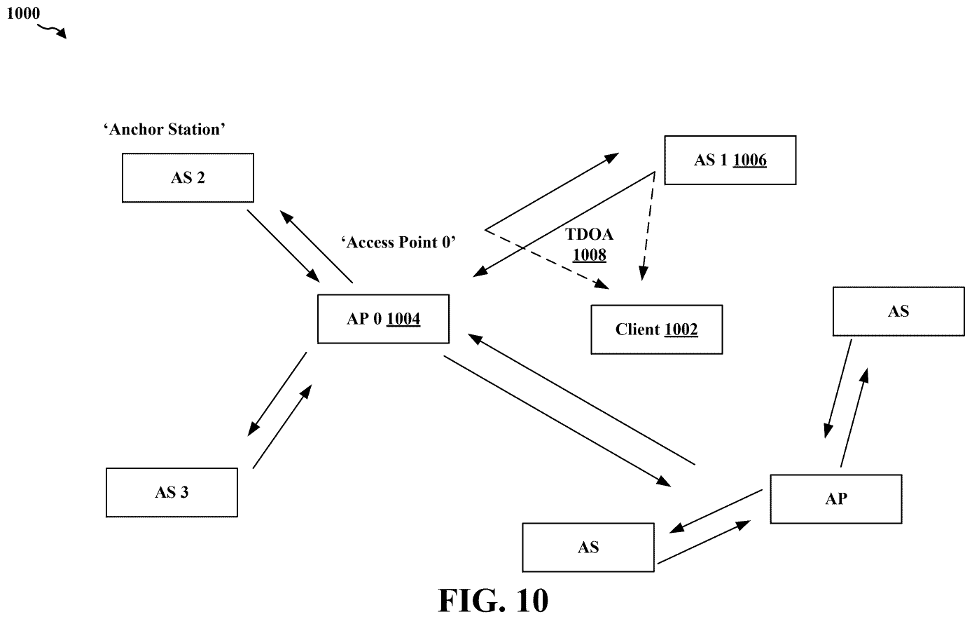

FIG. 10 is a diagram 1000 illustrating example aspects of passive location positioning. Passive location positioning may also be referred to as “passive ranging.” In passive ranging, a location of a client 1002 (e.g., a UE) may be determined, where the client 1002 does not transmit signals for location determination. Instead, access point 0 (AP0) 1004 may transmit a first signal that is received by a first anchor station (AS1) 1006 and the client 1002. The client 1002 may obtain a first time of arrival (ToA) of the first signal upon receiving the first signal. AS1 1004 may be an access point. When AS1 1006 receives the first signal transmitted by AP0 1004, AS1 1006 may transmit a second signal that is received by AP0 1004 and the client 1002. The client 1002 may obtain a second ToA of the second signal upon receiving the second signal. The client 1002 may compute a time difference of arrival (TDOA) 1008 based on the first ToA of the first signal and the second ToA of the second signal. For instance, the client 1002 may obtain a hyperbolic equation based on the first ToA and the second ToA that is indicative of a location of the client 1002.

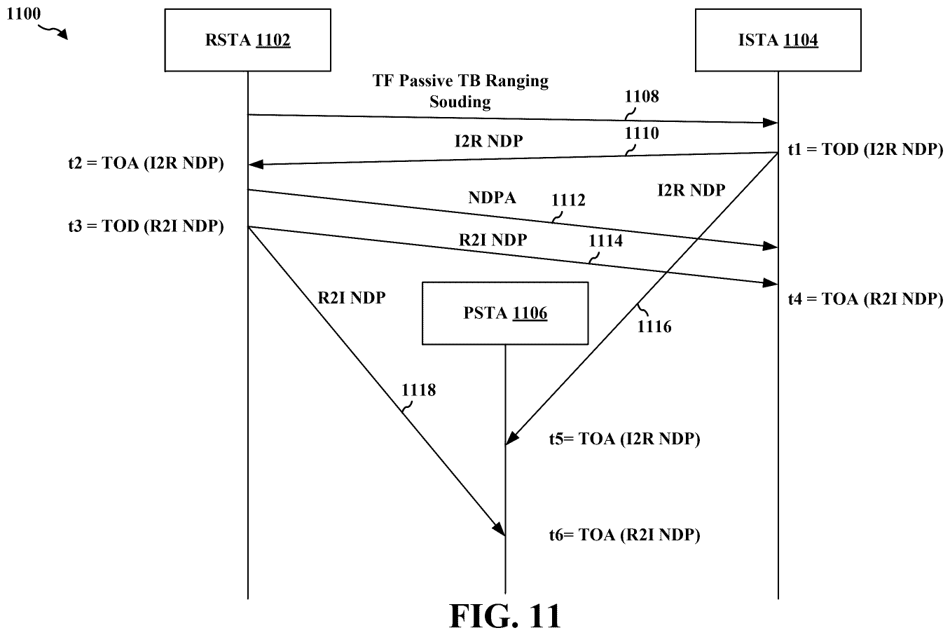

FIG. 11 is a diagram 1100 illustrating an example of performing passive location positioning. The diagram 1100 depicts a RSTA 1102, a ISTA 1104, and a PSTA 1106. At 1108, the RSTA 1102 may perform TF passive TB ranging sounding. The TF passive TB ranging sounding may include aspects described above in the description of FIG. 9. At 1110 (time t1), the ISTA 1104 may transmit a NDP (I2R NDP) which may be received by the RSTA 1102 at time t2. Time t1 may be equal to a time of departure (TOD) of the I2R NDP. Time t2 may be equal to a time of arrival (TOA) of the I2R NDP.

At 1112, the RSTA 1102 may transmit a NDP acknowledgment (NDPA) to the ISTA 1104. At 1114 (time t3), the RSTA 1102 may transmit a NDP (R2I NDP) which may be received by the ISTA 1104 at time t4. Time t3 may be equal to a TOD of the R2I NDP and time t4 may be equal to a TOA of the R2I NDP.

At 1116 (time t5), the PSTA 1106 may receive the I2R NDP transmitted by the ISTA 1104 at time t1. Time t5 may be equal to a TOA of the I2R NDP. The PSTA 1106 may measure a TOA of the I2R NDP. At 1118 (time t6), the PSTA 1106 may receive the R2I NDP transmitted by the RSTA 1102 at time t3. Time t6 may be equal to a TOA of the R2I NDP. The PSTA 1106 may measure a TOA of the R2I NDP. The PSTA 1106 may also receive a TOA and a TOD from the RSTA 1102 and the ISTA 1104 in a location measurement report (LMR). The PSTA 1106 may utilize hyperbolic navigation to compute respective locations of the RSTA 1102 and the ISTA 1104 using the measurements performed by the PSTA 1106 and data in the LMR.

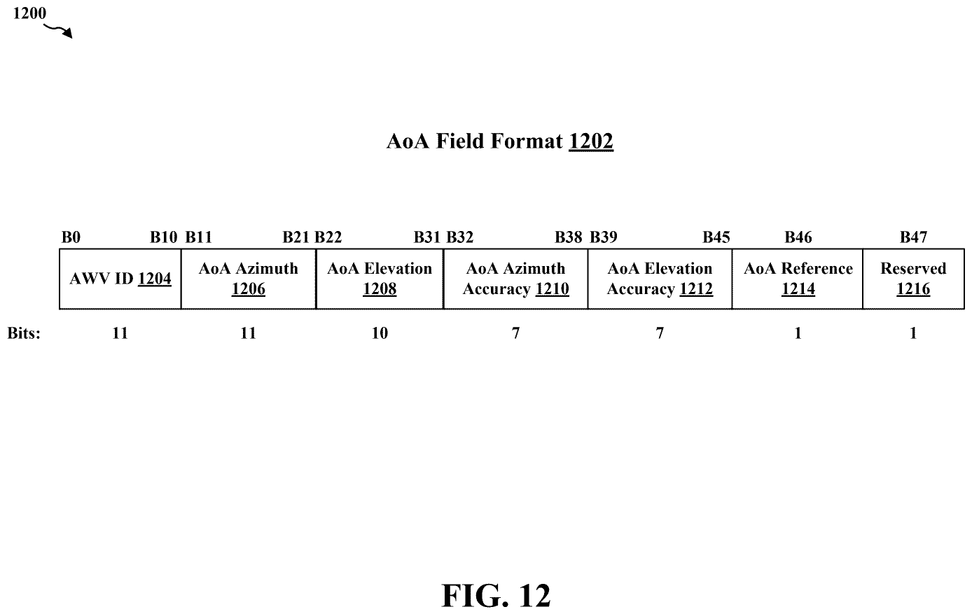

FIG. 12 is a diagram 1200 illustrating an example of an AoA field format 1202. The AoA field format 1202 may be utilized in a LMR. The AoA field format 1202 may have a length of 48 bits. The AoA field format 1202 may include an antenna weight vector (AWV) ID 1204. The AWV ID 1204 may be 11 bits long.

The AoA field format 1202 may include a AoA azimuth subfield 1206. The AoA azimuth subfield 1206 may include an AoA azimuth result in 360°/2048 resolution. The AoA azimuth subfield 1206 may include an unsigned 2s complement number that may take values from 0 to 2047 (inclusive). The AoA azimuth subfield 1206 may be 11 bits long.

The AoA field format 1202 may include a AoA elevation subfield 1208. The AoA elevation subfield 1208 may include a AoA elevation result in 180°/1024 resolution. The AoA elevation subfield 1208 may include a signed 2s complement number that may take values from −512 to 511 (inclusive). The AoA elevation subfield 1208 may be 10 bits long.

The AoA field format 1202 may include a AoA azimuth accuracy subfield 1210. The AoA azimuth accuracy subfield 1210 may include an estimated accuracy of the AoA azimuth result in the AoA azimuth subfield 1206 in 360°/2048 resolution. Accuracy values that are larger than 125×3600/2048 resolution may be represented by a value of 125 in the AoA azimuth accuracy subfield 1210. A value of 126 in the AoA azimuth accuracy subfield 1210 may indicate no azimuth measurement was performed. A value of 127 in the AoA azimuth accuracy subfield 1210 may indicate a lack of an ability to estimate azimuth accuracy. The AoA azimuth accuracy subfield 1210 may be 7 bits long.

The AoA field format 1202 may include a AoA elevation accuracy subfield 1212. The AoA elevation accuracy subfield 1212 may include an estimated accuracy of the AoA elevation result in the AoA elevation subfield 1208 in 360°/2048 resolution. Accuracy values that are larger than 125×3600/2048 resolution may be represented by a value of 125 in the AoA elevation accuracy subfield 1212. A value of 126 in the AoA elevation accuracy subfield 1212 may indicate no elevation measurement was performed. A value of 127 in the AoA elevation accuracy subfield 1212 may indicate a lack of an ability to estimate an elevation accuracy. The AoA elevation accuracy subfield 1212 may be 7 bits long.

The AoA field format 1202 may include a AoA reference subfield 1214. The AoA reference subfield 1214 may be 1-bit in length. The AoA reference subfield 1214 may be a field that provides information with regard to a reference for AoA estimation. The AoA field format 1202 may include a reserved field 1216. The reserved field 1216 may be 1-bit in length.

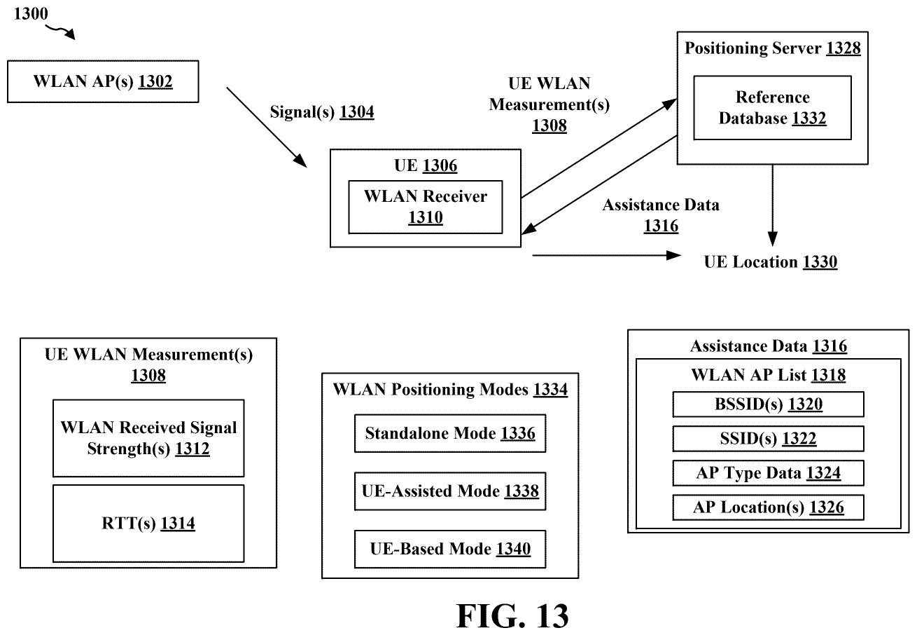

FIG. 13 is a diagram 1300 illustrating example aspects of wireless local area network (WLAN) based positioning in a long-term evolution (LTE) positioning protocol (LPP). WLAN positioning may make use of WLAN measurements, AP identifiers, and other measurements and databases to determine a location of a UE. For instance, a position/location of the UE may be estimated with knowledge of geographical coordinates of WLAN APs via collecting a certain amount of measurements from a WLAN receiver of the UE and applying a location determination algorithm using databases of estimated position reference points. The UE may measure received signals from WLAN APs (potentially aided by assistance data) to send measurements to a positioning server for position calculation. Using the measurement results and a reference database, a location of the UE may be calculated. Alternatively, the UE may make use of WLAN measurements and potentially WLAN assistance data provided by the positioning server to determine a location of the UE.

In an example, WLAN AP(s) 1302 may transmit signal(s) 1304. A UE 1306 may perform UE WLAN measurement(s) 1308 on the signal(s) 1304 using a WLAN receiver 1310 (e.g., an 802.11-az based WLAN receiver) of the UE 1306. The UE WLAN measurement(s) 1308 may include WLAN received signal strength(s) 1312. In an example, the WLAN received signal strength(s) 1312 may be received signal strength indicator (RSSI) measurement(s). The UE WLAN measurement(s) 1308 may include RTT(s) 1314 of the signal(s) 1304 between the WLAN AP(s) 1302 and the UE 1306.

The UE 1306 may obtain assistance data 1316 which the UE 1306 may utilize to facilitate performing the UE WLAN measurement(s) 1308. For instance, the UE 1306 may utilize the assistance data 1316 to perform the UE WLAN measurement(s) 1308. In an example, the assistance data 1316 may be obtained from a LMF of a core network and/or from a positioning server 1328. The assistance data 1316 may include a WLAN AP list 1318 that includes information pertaining to the WLAN AP(s) 1302. The WLAN AP list 1318 may include basic service set identifier(s) (BSSID(s)) 1320 for the WLAN AP(s) 1302. The BSSID(s) 1320 may identify the WLAN AP(s) 1302 and client devices associated with the WLAN AP(s). The WLAN AP list 1318 may include service set identifier(s) (SSID(s)) 1322 that identify network(s) associated with the WLAN AP(s) 1302. The WLAN AP list 1318 may include AP type data 1324 that indicates characteristics associated with the WLAN AP(s) 1302. For instance, the AP type data 1324 may include WLAN types (e.g., 802.11a/b/g/n/ac/ad/az, etc.) supported by the WLAN AP(s) 1302, transmit power of the WLAN AP(s) 1302, antenna gain supported by the WLAN AP(s) 1302, coverage area(s) of the WLAN AP(s) 1302, etc. The WLAN AP list 1318 may include AP location(s) 1326 of the WLAN AP(s) 1302. The AP location(s) 1326 may include latitude(s), longitude(s), altitude(s), uncertainties for the latitude(s), uncertainties for the longitude(s), uncertainties for the altitudes, and/or additional data. The provision and/or usage of some or all of the aforementioned elements of the assistance data 1316 may depend on NG-RAN capabilities and UE capabilities, respectively.

The UE 1306 may support different types of WLAN positioning modes 1334. The WLAN positioning modes 1334 may include a standalone mode 1336, a UE-assisted mode 1338, and a UE-based mode 1340. In the standalone mode 1336, the UE 1306 may perform the UE WLAN measurement(s) 1308 (i.e., WLAN position measurements) and location computations in order to determine a location of the UE (a “UE location 1330”) without network assistance (e.g., without assistance from a LMF and/or a positioning server 1328). In the U-assisted mode 1338, the UL 1306 provides the U WLAN measurement(s) 1308 (i.e., WLAN position measurements) with or without assistance from the network to a LMF for computation of the U location 1330 by the network. For instance, the UE 1306 may transmit the UE LWLAN measurement(s) to a positioning server 1328. The positioning server 1328 may determine the UE location 1330 using a location determination algorithm that utilizes the WLAN measurement(s) and data in a reference database 1332. In the UE-based mode 1340, the UE 1306 may perform the UE WLAN measurement(s) 1308 (i.e., WLAN position measurements) and compute the UE location 1330 with network assistance. For instance, the positioning server 1328 may provide the assistance data 1316 and/or data from the reference database 1332 to the UE 1306 and the UE 1306 may determine the UE location 1330 based on the UE WLAN measurement(s) 1308 and the assistance data 1316 and/or the data from the reference database 1332. Table 2 below details information that may be transferred from a UE to a LMF in a LPP capability transfer procedure.

TABLE 2
WLAN Location Information and UE Location Information
that may be sent from a UE to a LMF

| Information | UE-Assisted | UE-based/Standalone |
|---|---|---|
| WLAN Location | | |
| Information | | |
| BSSID | Yes | No |
| SSID | Yes | No |
| Received Signal | Yes | No |
| Strength (RSSI) | | |
| Round Trip Time | Yes | No |
| (RTT) | | |
| Time Stamp | Yes | No |
| Measurement | Yes | No |
| Characteristics | | |
| UE Location | | |
| Information | | |
| UE Position Estimate | No | Yes |
| with Uncertainty Shape | | |
| Position Time Stamp | No | Yes |
| Location Source | No | Yes |
| (method(s) used to | | |
| compute location) | | |

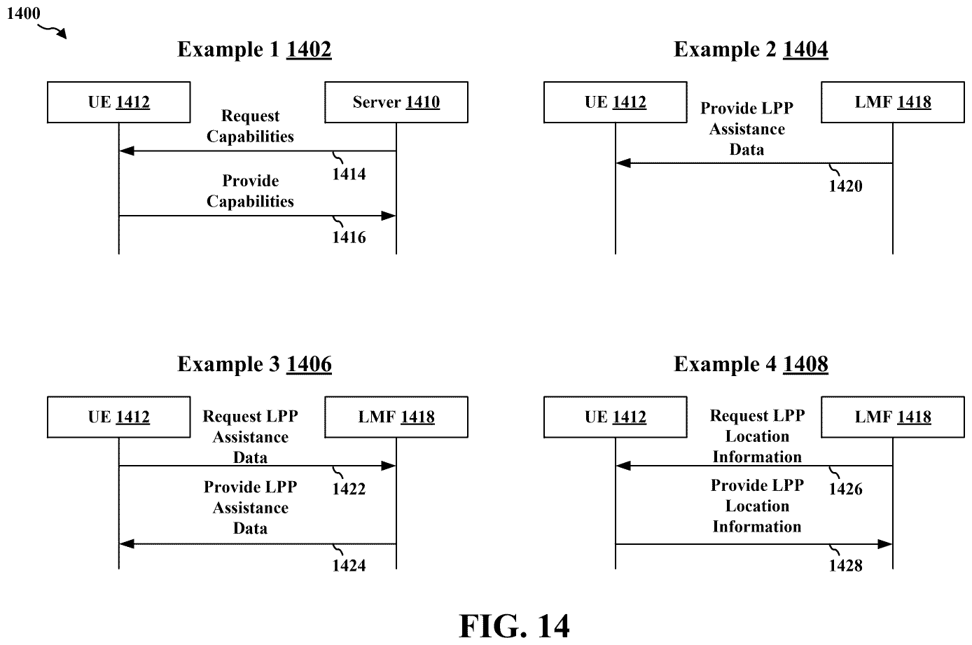

FIG. 14 is a diagram 1400 illustrating example aspects pertaining to WiFi status in a long-term evolution (LTE) positioning protocol (LPP). The diagram 1400 depicts a first example 1402, a second example 1404, a third example 1406, and a fourth example 1408.

In the first example 1402, at 1414, a server 1410 may transmit a request for UE capabilities of a UE 1412. The request may indicate particular types of capabilities of the UE 1412 that the server 1410 is requesting. The capabilities may refer to positioning and protocol capabilities related to LPP and positioning methods supported by LPP. The server 1410 may be part of a core network and may include a LMF. The server 1410 may be or include a LMF. At 1416, based on receiving the request, the UE 1412 may transmit an indication of the UE capabilities (e.g., indications of the particular types of capabilities) to the server 1410. Alternatively, the UE 1412 may transmit the indication of the UE capabilities without receiving a request from the server 1410.

In the second example 1404, at 1420, a LMF 1418 may transmit LPP assistance data to the UE 1412 without receiving a request from the UE 1412. The LMF 1418 may be or include the server 1410. The LPP assistance data may be or include the assistance data 1316 (or other assistance data described herein).

In the third example 1406, at 1422, the UE 1412 may transmit a request for LPP assistance data to the LMF 1418. At 1424, the LMF 1418 may transmit the LPP assistance data to the UE 1412 based on receiving the request. The LPP assistance data may be or include the assistance data 1316 (or other assistance data described herein).

In the fourth example 1408, at 1426, the LMF 1418 may transmit a request for LPP location information to the UE 1412. At 1428, the UE 1412 may transmit the LPP location information to the LMF 1418 based on receiving the request. The LPP location information may include a latitude, a longitude, and an altitude of the UE 1412. The LPP location information may also include respective uncertainties of the latitude, the longitude, and the altitude.

As discussed above, 802.11-az based positioning may include support for MIMO, MU-MIMO, AoD/AoA measurements, passive positioning/passive ranging, MAC security, and/or PHY security. Such features may not be supported by other types of positioning technologies, such as positioning technologies that utilize FTM. Furthermore, some types of LPP signaling may not include support for the aforementioned features.

Various technologies pertaining to 801.11az based positioning support for LPP are described herein. In an example, a UE obtains assistance data that indicates at least one WLAN AP supports a first type of WiFi-based positioning, where the first type of WiFi-based positioning is associated with at least one of: MIMO, a set of security features, passive positioning, or angle measurement support. The UE transmits an indication that the UE supports the first type of WiFi-based positioning. The UE receives a request to perform a set of measurements based on the first type of WiFi-based positioning. The UE performs, based on the request, the set of measurements for the first type of WiFi-based positioning. The UE outputs an indication of the set of performed measurements for the first type of WiFi-based positioning. Vis-à-vis the aforementioned technologies, the UE may be informed that the at least one WLAN AP supports the first type of WiFi-based positioning (e.g., 802.11-az based positioning). The UE may then perform the set of measurements using the first type of WiFi-based positioning. Thus, the aforementioned technologies may facilitate a more accurate location determination of the UE in comparison to other types of WiFi-based positioning.

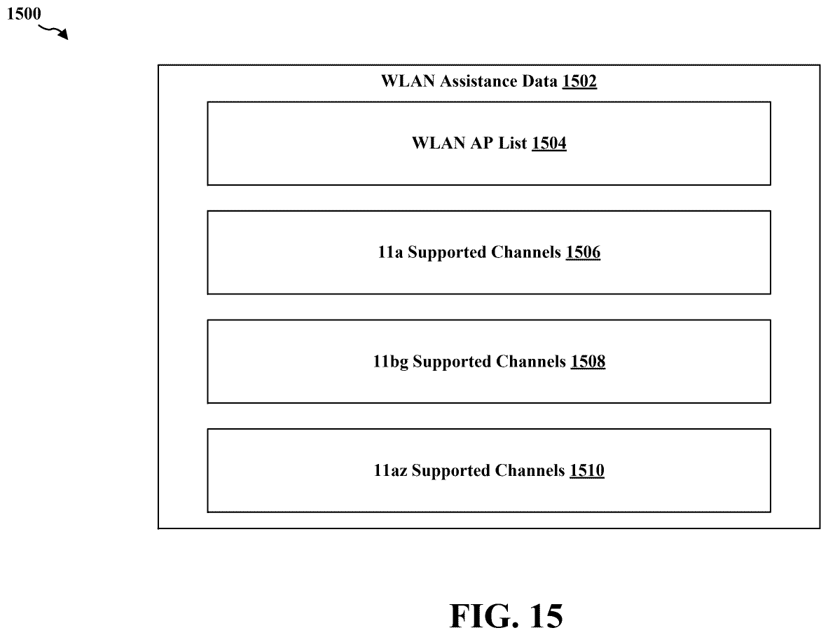

FIG. 15 is a diagram 1500 illustrating example aspects of WLAN assistance data 1502. The WLAN assistance data 1502 may be provided to a UE with or without a request from the UE as in the second example 1404 and the third example 1406 of FIG. 14, respectively. The WLAN assistance data 1502 may include a WLAN AP list 1504. The WLAN AP list 1504 may be a field that provides information for WLAN APs in a data set. The WLAN AP list 1504 may be or include the WLAN AP list 1318 (or a portion thereof) described in FIG. 13. The WLAN assistance data 1502 may include a 11a supported channels field 1506 that defines a superset of channels supported by WLAN APs in the data set of type 801.11a (5 GHz band). The WLAN assistance data 1502 may include a 11bg supported channels field 1508 that defines a superset of channels supported by WLAN APs in the data set of type 801.11b or 802.11g (2.4 GHz band). The WLAN assistance data 1502 may include a 11az supported channels field 1510 that defines a superset of channels supported by WLAN APs in the data set of type 801.11az (6 GHz) with 160 MHz and 320 MHz support.

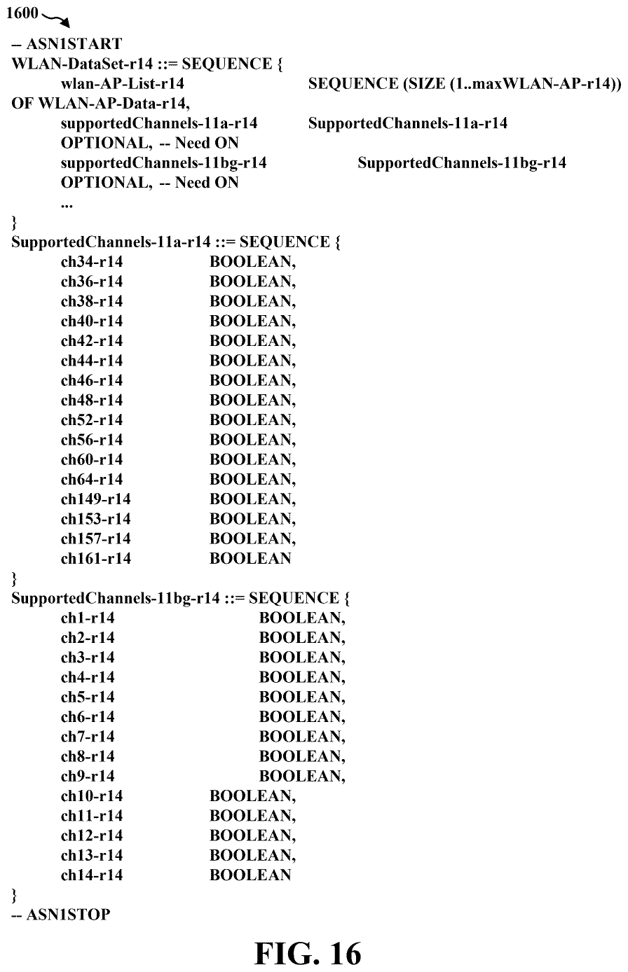

FIG. 16 is a diagram 1600 illustrating further aspects of WLAN assistance data. The aspects illustrated in the diagram 1600 may correspond to one or more of the aspects of the WLAN assistance data 1502 described above.

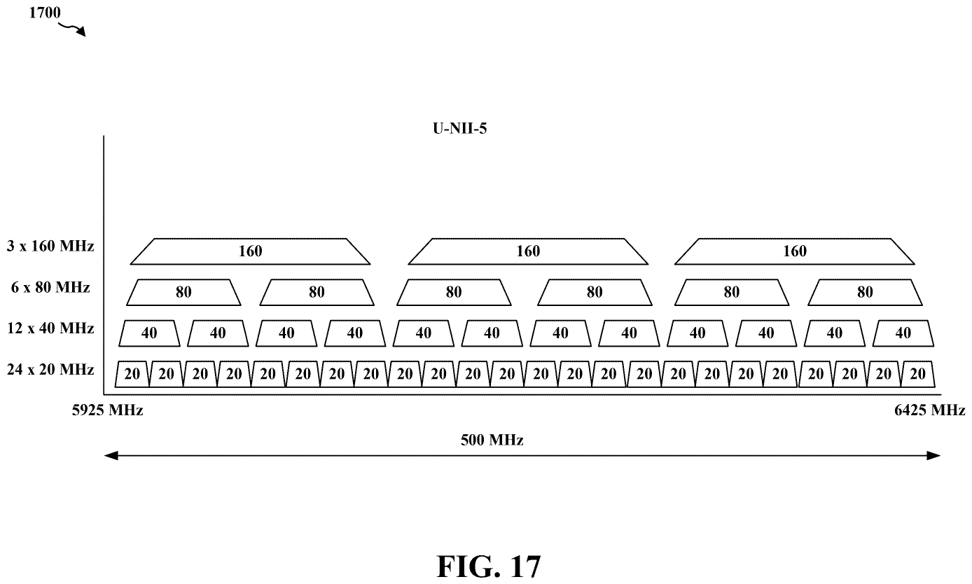

FIG. 17 is diagram 1700 illustrating example aspects of channels supported by 802.11az. 802.11az may be associated with unlicensed national information infrastructure (U-NII) band 5 (U-NII-5). 802.11az may support three 160 MHz channels, six 80 MHz channels, twelve 40 MHz channels, and/or twenty-four 20 MHz channels. 802.11az may support a bandwidth of 500 MHz. 802.11az may have a frequency range of 5925 MHz-6425 MHz.

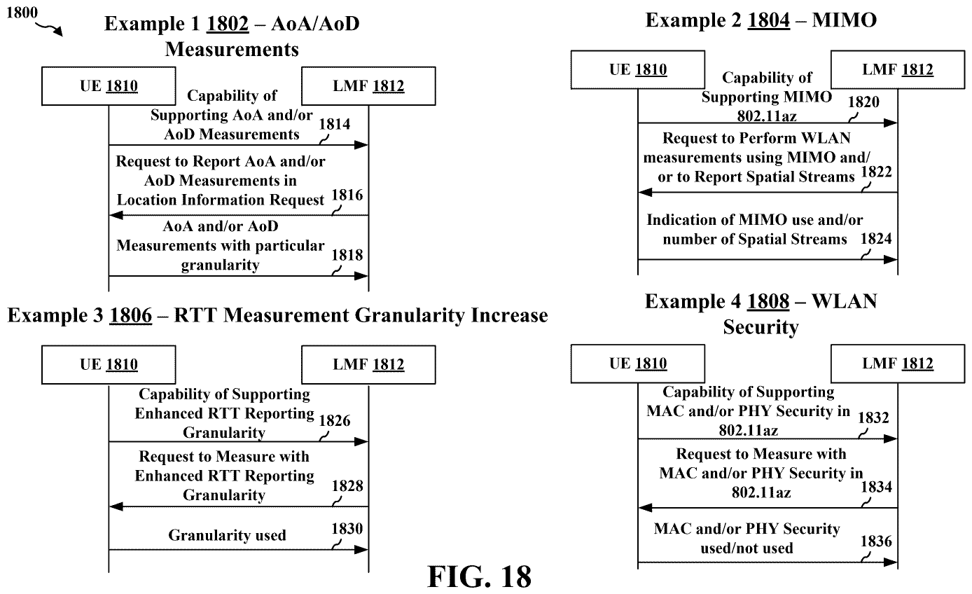

FIG. 18 is a diagram 1800 illustrating example aspects of signaling pertaining to 802.11az. The diagram 1800 depicts a first example 1802, a second example 1804, a third example 1806, and a fourth example 1808. The first example 1802, the second example 1804, the third example 1806, and/or the fourth example 1808 may include aspects described above in connection with FIG. 14. The first example 1802, the second example 1804, the third example 1806, and/or the fourth example 1808 may be associated with LPP signaling and/or 802.11az based positioning as described above. LPP signaling may refer to configuration information for reference signals that may be measured, as well as AP information.

In the first example 1802, at 1814, the UE 1810 may transmit (e.g., via LPP signaling) an indication that the UE 1810 is capable of supporting AoA and/or AoD reporting (i.e., the UE 1810 is capable of performing and reporting AoA and/or AoD measurements). AoD measurements may correspond to a AoD measurement of an AP. AoA measurements may correspond to a AoA measurement of the UE 1810. At 1816, based on receiving the indication, the LMF 1812 may transmit (e.g., via LPP signaling) a request (i.e., a WiFi-related location information request, a location information request) for the UE 1810 to report a AoA measurement and/or a AoD measurement. At 1818, based on receiving the request, the UE 1810 may perform the AoA measurement and/or the AoD measurement and the UE 1810 may transmit (e.g., via LPP signaling) an indication of the AoA measurement and/or the AoD measurement to the LMF 1812. The AoA measurement and/or the AoD measurement may be reported to the LMF 1812 at a granularity associated with 802.11az or the AoA measurement and/or AoD measurement may be reported to the LMF 1812 at a 3GPP reporting granularity (e.g., 1 degree or 0.1 degrees). The granularity may refer to a quantization level (e.g., a reporting level in degrees (−360, −359, −358, . . . 360). In an example, the request (i.e., the location information request) may indicate the granularity at which the UE 1810 is to report the AoA measurement and/or the AoD measurement.

In the second example 1804, at 1820, the UE 1810 may transmit (e.g., via LPP signaling) an indication that the UE 1810 is capable of supporting MIMO 802.11az. At 1822, based on receiving the indication, the LMF 1812 (or a location server) may transmit (e.g., via LPP signaling) a request for the UE 1810 to perform WLAN measurements using MIMO 802.11az. Additionally, or alternatively, the request may be for the UE 1810 to report a number of spatial streams used for the WLAN measurements. At 1824, based on receiving the request, the UE 1810 may perform the WLAN measurements using MIMO 802.11az and transmit (e.g., via LPP signaling) an indication of the WLAN measurements to the LMF 1812. Additionally, or alternatively, the UE 1810 may transmit an indication of the number of spatial streams that were used for the WLAN measurements if the request indicated that the UE 1810 was to report the number of spatial streams.

In the third example 1806, at 1826, the UE 1810 may transmit (e.g., via LPP signaling) an indication that the UE 1810 is capable of supporting an enhanced RTT reporting granularity. RTT reporting granularity may refer to a quantization level of a timing domain measurement. For example, a 1 nanosecond granularity may refer to a measurement that is quantized at 1 nanosecond granularity. For instance, a RTT reporting granularity associated with 3GPP LPP may be 0.1 nanoseconds and the enhanced RTT reporting granularity may be 0.01 nanoseconds (10 picoseconds) or 0.001 nanoseconds (1 picosecond) for the purpose of supporting WLAN measurements performed using 802.11az. At 1828, based on receiving the indication, the LMF 1812 may transmit (e.g., via LPP signaling) a request (e.g., a location information request, a location information request message, etc.) for the UE 1810 to report the RTT measurements using the enhanced RTT reporting granularity (e.g., 0.01 nanoseconds or 0.001 nanoseconds). At 1830, based on receiving the request, the UE 1810 may transmit (e.g., via LPP signaling) an indication of whether the UE 1810 used the enhanced RTT reporting granularity for the WLAN measurements or another RTT reporting granularity.

In the fourth example 1808, at 1832, the UE 1810 may transmit (e.g., via LPP signaling) an indication that the UE 1810 is capable of supporting MAC security and/or PHY security in 802.11az. At 1834, based on receiving the indication, the LMF 1812 may transmit (e.g., via LPP signaling) a request for the UE 1810 to perform WLAN measurements using MAC security and/or PHY security. At 1836, based on receiving the request, the UE 1810 may perform the WLAN measurements and the UE 1810 may transmit (e.g., via LPP signaling) an indication of whether the UE 1810 utilized MAC security and/or PHY security to perform the WLAN measurements. For instance, the UE 1810 may transmit a WiFi security status report that indicates whether the UE 1810 utilized MAC security and/or PHY security to perform the WLAN measurements. The WiFi status security report may be associated with integrity check reporting to the LMF 1812.

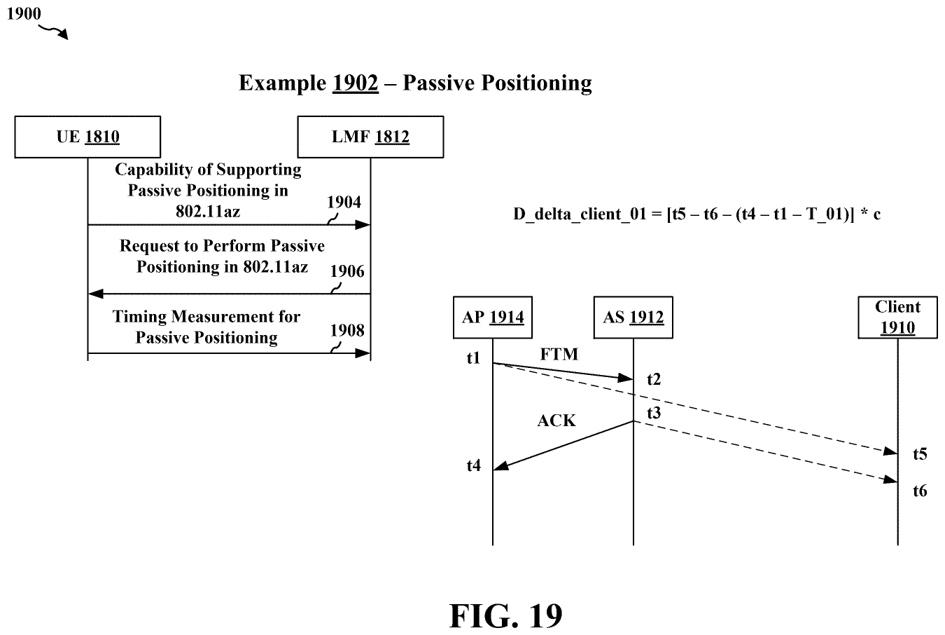

FIG. 19 is a diagram 1900 illustrating further example aspects of signaling pertaining to 802.11az. The diagram 1900 includes an example 1902 pertaining to passive positioning using 802.11az. The example 1902 may be associated with LPP signaling and/or 802.11az based positioning as described above.

At 1904, the UE 1810 may transmit (e.g., via LPP signaling) an indication that the UE 1810 is capable of supporting passive positioning in 802.11az. At 1906, based on receiving the indication, the LMF 1812 may transmit a request (e.g., via LPP signaling) for the UE 1810 to perform passive positioning in 802.11az. The request may include an indication of AP(s) that are to be utilized for performing the passive positioning. At 1908, based on receiving the request, the UE 1810 may transmit (e.g., via LPP signaling) an indication of a timing measurement (e.g., in nanoseconds) for the passive positioning. The timing measurement may not be a RTT measurement.

The diagram 1900 further depicts communications between a client 1910 (e.g., the UE 1810), an AS 1912, and an AP 1914 used for calculating a differential distance of the client 1910 from the AS 1912 and the AP 1914. At time t1, the AP 1914 may transmit a FTM that may be received by the AS 1912 at time t2. At time t3, the AS 1912 may transmit an ACK that may be received by the AP 1914 at time t0. At time t5, the client 1910 may receive the FTM transmitted by the AP 1914 at t1. At time t6, the client may receive a signal transmitted by the AS 1912 at time t3. The differential distance (“D_delta_client_01”) from the client 1910 to the AP 1914 and the AS 1912 may be calculated according to equation (II) below:

$$D\_delta \_client \_ 01 = [ t 5 - t 6 - ( t 4 - t 1 - T\_ 01 ) ] * c \qquad ( II )$$

In equation (II), “T_01” may refer to a time of flight for a signal between the AP 1914 and the AS 1912 and “c” may be the speed of light.

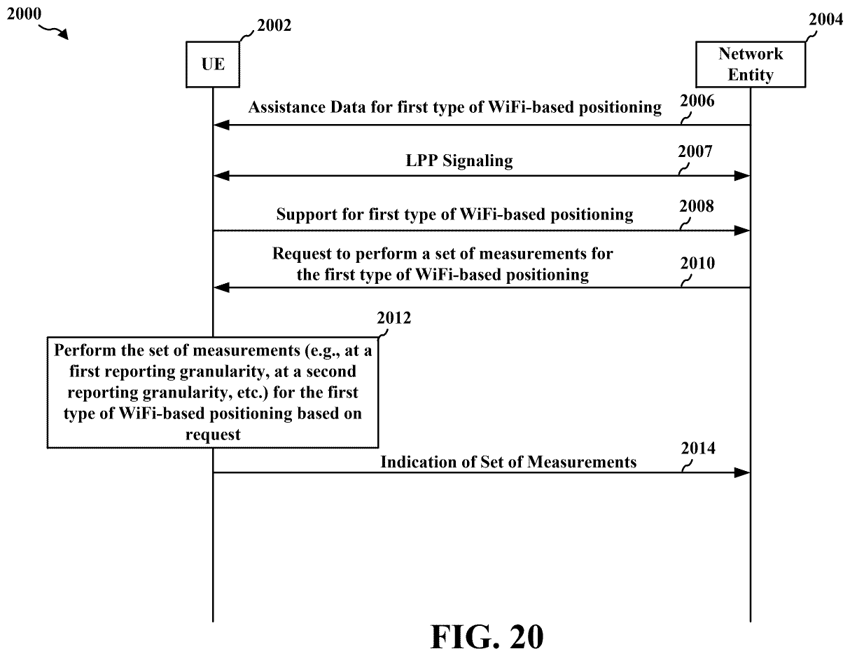

FIG. 20 is a diagram 2000 illustrating example communications between a UE 2002 and a network entity 2004. The UE 2002 may be or include the UE 104, the UE 350, the UE 404, the UE 502, the UE 602, the client 1002, the PSTA 1106, the UE 1306, the UE 1412, the UE 1810, the client 1910, and/or the apparatus 2504. The network entity 2004 may be or include the core network 120, the LMF 166, the LMF 606, the positioning server 1328, the server 1410, the LMF 1418, the LMF 1812, and/or the network entity 2760.

At 2006, the network entity 2004 may transmit assistance data for a first type of WiFi-based positioning (e.g., 802.11az based positioning), where the assistance data indicates that WLAN AP(s) support the first type of WiFi-based positioning. The first type of WiFi-based positioning may be associated with at least one of: MIMO, a set of security features, passive positioning, or angle measurement support. At 2008, the UE 2002 may transmit an indication that the UE supports the first type of WiFi-based positioning based on the assistance data. At 2010, the network entity 2004 may transmit a request for the UE 2002 to perform a set of measurements based on the first type of WiFi-based positioning. At 2012, the UE 2002 may perform a set of measurements for the first type of WiFi-based positioning based on the request. At 2014, the UE 2002 may transmit an indication of the set of measurements to the network entity 2004.

In one aspect, at 2007, the UE 2002 may transmit or receive LPP signaling associated with the WLAN AP(s). Furthermore, in such an aspect, the request received at 2010, the indication of support transmitted at 2008, and/or the indication of the set of measurements transmitted at 2014 may be associated with the LPP signaling.

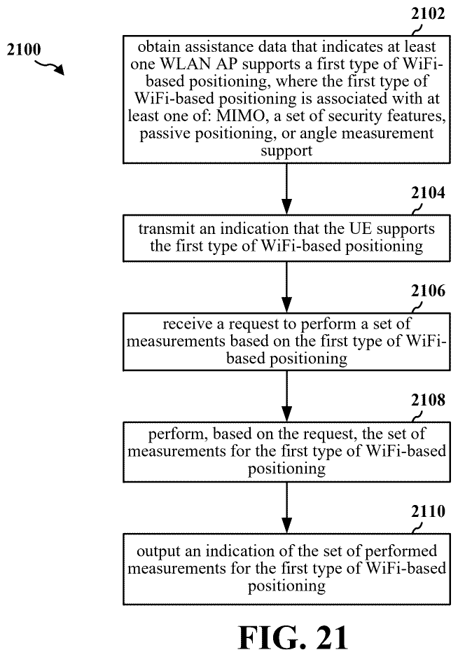

FIG. 21 is a flowchart 2100 of a method of wireless communication. The method may be performed by a UE (e.g., the UE 104, the UE 350, the UE 404, the UE 502, the UE 602, the responding station 702, the initiating station 704, the client 1002, the RSTA 1102, the ISTA 1104, the PSTA 1106, the UE 1306, the UE 1412, the UE 1810, the client 1910, the UE 2002, the apparatus 2504). The method may be associated with various advantages at the UE, such as facilitating 802.11az based positioning. In an example, the method may be performed by the WiFi positioning component 198.

At 2102, the UE obtains assistance data that indicates at least one WLAN AP supports a first type of WiFi-based positioning, where the first type of WiFi-based positioning is associated with at least one of: MIMO, a set of security features, passive positioning, or angle measurement support. For example, FIG. 20 at 2006 shows that the UE 2002 may obtain assistance data that indicates that at least one WLAN AP supports a first type of WiFi-based positioning, where the first type of WiFi-based positioning is associated with at least one of: MIMO, a set of security features, passive positioning, or angle measurement support. In an example, MIMO may correspond to the MIMO support 804 and/or the MU support 810 described above, the set of security features may correspond to the MAC security support 806 and/or the PHY security support 808 described above, the passive positioning may correspond to the passive ranging support 812 described above, and the angle measurement support may correspond to the AoA/AoD support 814 described above. Passive positioning may include aspects described above in the description of FIGS. 9-11. Angle measurement support may include aspects described above in the description of FIG. 12. In an example, the assistance data may be or include the assistance data 1316, the LPP assistance data described in the second example 1404 and/or the third example 1406 of FIG. 14, the WLAN assistance data 1502, and/or the WLAN assistance data illustrated in FIG. 16. In an example, the at least one WLAN AP may be or include the WLAN AP(s) 1302. In an example, 2102 may be performed by the WiFi positioning component 198.

At 2104, the UE transmits an indication that the UE supports the first type of WiFi-based positioning. For example, FIG. 20 at 2008 shows that the UE 2002 may transmit an indication that the UE supports the first type of WiFi-based positioning. In an example, the indication that the UE supports the first type of WiFi-based positioning may correspond to the transmissions of the UE 1810 at 1814, 1820, 1826, 1832, and/or 1904. In an example, 2104 may be performed by the WiFi positioning component 198.

At 2106, the UE receives a request to perform a set of measurements based on the first type of WiFi-based positioning. For example, FIG. 20 at 2010 shows that the UE 2002 may receive a request to perform a set of measurements based on the first type of WiFi-based positioning. In an example, the request may correspond to the transmissions received by the UE 1810 at 1816, 1822, 1828, 1834, and/or 1906. In an example, 2106 may be performed by the WiFi positioning component 198.

At 2108, the UE performs, based on the request, the set of measurements for the first type of WiFi-based positioning. For example, FIG. 10 at 2012 shows that the UE 2002 may perform the set of measurements for the first type of WiFi-based positioning. In an example, 2108 may be performed by the WiFi positioning component 198.

At 2110, the UE outputs an indication of the set of performed measurements for the first type of WiFi-based positioning. For example, FIG. 20 at 2014 shows that the UE 2002 may output an indication of a set of performed measurements for the first type of WiFi-based positioning. In an example, the indication of the set of performed measurements may correspond to the transmissions of the UE 1810 at 1818, 1824, 1830, 1836, and/or 1908. In an example, 2110 may be performed by the WiFi positioning component 198.

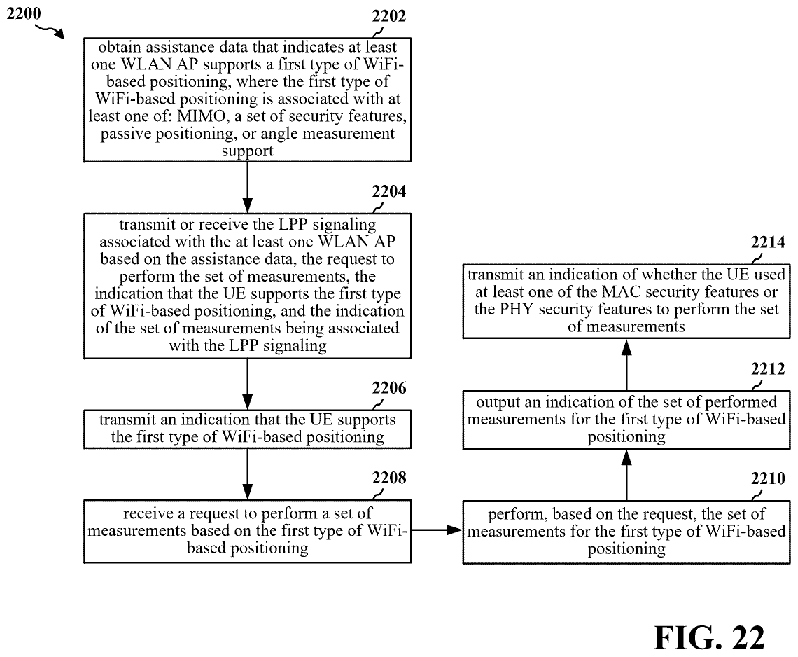

FIG. 22 is a flowchart 2200 of a method of wireless communication. The method may be performed by a UE (e.g., the UE 104, the UE 350, the UE 404, the UE 502, the UE 602, the responding station 702, the initiating station 704, the client 1002, the RSTA 1102, the ISTA 1104, the PSTA 1106, the UE 1306, the UE 1412, the UE 1810, the UE 2002, the apparatus 2504). The method may be associated with various advantages at the UE, such as facilitating 802.11az based positioning. In an example, the method (including the various aspects detailed below) may be performed by the WiFi positioning component 198.

At 2202, the UE obtains assistance data that indicates at least one WLAN AP supports a first type of WiFi-based positioning, where the first type of WiFi-based positioning is associated with at least one of: MIMO, a set of security features, passive positioning, or angle measurement support. For example, FIG. 20 at 2006 shows that the UE 2002 may obtain assistance data that indicates that at least one WLAN AP supports a first type of WiFi-based positioning, where the first type of WiFi-based positioning is associated with at least one of: MIMO, a set of security features, passive positioning, or angle measurement support. In an example, MIMO may correspond to the MIMO support 804 and/or the MU support 810 described above, the set of security features may correspond to the MAC security support 806 and/or the PHY security support 808 described above, the passive positioning may correspond to the passive ranging support 812 described above, and the angle measurement support may correspond to the AoA/AoD support 814 described above. Passive positioning may include aspects described above in the description of FIGS. 9-11. Angle measurement support may include aspects described above in the description of FIG. 12. In an example, the assistance data may be or include the assistance data 1316, the LPP assistance data described in the second example 1404 and/or the third example 1406 of FIG. 14, the WLAN assistance data 1502, and/or the WLAN assistance data illustrated in FIG. 16. In an example, the at least one WLAN AP may be or include the WLAN AP(s) 1302. In an example, 2202 may be performed by the WiFi positioning component 198.

At 2206, the UE transmits an indication that the UE supports the first type of WiFi-based positioning. For example, FIG. 20 at 2008 shows that the UE 2002 may transmit an indication that the UE supports the first type of WiFi-based positioning. In an example, the indication that the UE supports the first type of WiFi-based positioning may correspond to the transmissions of the UE at 1814, 1820, 1826, 1832, or 1904. In an example, 2206 may be performed by the WiFi positioning component 198.

At 2208, the UE receives a request to perform a set of measurements based on the first type of WiFi-based positioning. For example, FIG. 20 at 2010 shows that the UE 2002 may receive a request to perform a set of measurements based on the first type of WiFi-based positioning. In an example, the request may correspond to the transmissions received by the UE at 1816, 1822, 1828, 1834, and/or 1906. In an example, 2208 may be performed by the WiFi positioning component 198.

At 2210, the UE performs, based on the request, the set of measurements for the first type of WiFi-based positioning. For example, FIG. 10 at 2012 shows that the UE 2002 may perform the set of measurements for the first type of WiFi-based positioning. In an example, 2210 may be performed by the WiFi positioning component 198.

At 2212, the UE outputs an indication of the set of performed measurements for the first type of WiFi-based positioning. For example, FIG. 20 at 2014 shows that the UE 2002 may output an indication of a set of performed measurements for the first type of WiFi-based positioning. In an example, the indication of the set of performed measurements may correspond to the transmissions of the UE 1810 at 1818, 1824, 1830, 1836, and/or 1908. In an example, 2212 may be performed by the WiFi positioning component 198.

In one aspect, the first type of WiFi-based positioning may be associated with 802.11az-based positioning. In an example, the first type of WiFi-based positioning may support the 802.11-az features 802. In another example, 802.11az-based positioning may be associated with aspects described above in the description of FIG. 17.

In one aspect, the assistance data may include a WLAN assistance data element, and the assistance data may include a supported channels field that indicates that the at least one WLAN AP supports 802.11az-based channels for the 802.11az-based positioning. 802.11az-based channels may refer to bands or spectrums on which 802.11az is able to operate. For example, the assistance data may be the WLAN assistance data 1502 and the supported channels field may be or include the 11az supported channels field 1510.

In one aspect, the first type of WiFi-based positioning may be associated with the angle measurement support, where the indication that the UE supports the first type of WiFi-based positioning may indicate that the UE is capable of reporting one or more of at least one AoA or at least one AoD of at least one signal transmitted by the at least one AP, where the at least one AoD corresponds to the at least one AP, where the request to perform the set of measurements may indicate that the UE is to measure the one or more of the at least one AoA or the at least one AoD of the at least one signal, and where the indication of the set of measurements for the first type of WiFi-based positioning may include one or more of at least one AoA measurement or at least one AoD measurement of the at least one signal. For example, the aforementioned aspect may correspond to the first example 1802 of FIG. 18.

In one aspect, the set of measurements may include one of: a first reporting granularity corresponding to the first type of WiFi-based positioning, or a second reporting granularity corresponding to a second type of WiFi-based positioning. For example, the set of measurements performed at 2012 may include a first reporting granularity corresponding to the first type of WiFi-based positioning, or a second reporting granularity corresponding to a second type of WiFi-based positioning.

In one aspect, the first type of WiFi-based positioning may be associated with the MIMO, where the indication that the UE supports the first type of WiFi-based positioning may indicate that the UE is capable of MIMO-based positioning, where the request to perform the set of measurements may indicate one or more of: the UE is requested to perform the set of measurements using the MIMO or the UE is to report a number of spatial streams associated with the set of measurements, and where the indication of the set of measurements for the first type of WiFi-based positioning may include one or more of an indication of whether the UE used the MIMO to perform the set of measurements or an indication of the number of spatial streams. For example, the aforementioned aspect may correspond to the second example 1804 of FIG. 18.

In one aspect, the indication that the UE supports the first type of WiFi-based positioning may indicate that the UE supports a first RTT reporting granularity and a second RTT reporting granularity that is greater than the first RTT reporting granularity, where the request to perform the set of measurements may indicate that the UE is requested to perform the set of measurements using the first RTT reporting granularity, and where the indication of the set of measurements may indicate whether the UE performed the set of measurements using the first RTT reporting granularity. For example, the aforementioned aspect may correspond to the third example 1806 of FIG. 18.

In one aspect, the indication that the UE supports the first type of WiFi-based positioning may indicate that the UE supports the set of security features, where the set of security features may include at least one of MAC security features or PHY security features for the first type of WiFi-based positioning, where the request to perform the set of measurements may indicate that the UE is requested to perform the set of measurements using at least one of the MAC security features or the PHY security features. For example, the aforementioned aspect may correspond to the fourth example 1808 of FIG. 18. Furthermore, the fourth example 1808 of FIG. 18 shows that the set of security features may include MAC security features and/or PHY security features for the first type of WiFi-based positioning.

In one aspect, at 2214, the UE may transmit an indication of whether the UE used at least one of the MAC security features or the PHY security features to perform the set of measurements. For example, FIG. 18 at 1836 shows that the UE 1810 may transmit an indication of whether the UE used at least one of the MAC security features or the PHY security features to perform the set of measurements. In an example, 2214 may be performed by the WiFi positioning component 198.

In one aspect, the first type of WiFi-based positioning may be associated with the passive positioning, where the request to perform the set of measurements may indicate that the UE is requested to perform the passive positioning, and the set of measurements may include a set of timing measurements for the passive positioning. For example, the aforementioned aspect may correspond to the example 1902 of FIG. 19.

In one aspect, the request to perform the set of measurements may further indicate one or more of the at least one WLAN AP that are to be utilized for the passive positioning. For example, the request received by the UE 2002 at 2010 may indicate one or more of the WLAN AP(s) 1302.

In one aspect, the assistance data may be obtained from a LMF of a network entity, where the request to perform the set of measurements may be received from the LMF of the network entity, and the indication that the UE supports the first type of WiFi-based positioning and the indication of the set of measurements may be transmitted for the LMF of the network entity. For example, the second example 1404 and the third example 1406 of FIG. 14 shows that the UE 1412 may obtain LPP assistance data from the LMF 1418. Furthermore, FIG. 18 at 1816, 1822, 1828, and 1834 and FIG. 19 at 1906 show that the request to perform the set of measurements may be received from the LMF 1812. Additionally, FIG. 18 at 1814, 1820, 1826, and 1832 and FIG. 19 at 1904 show that the indication that the UE supports the first type of WiFi-based positioning may be transmitted for the LMF 1812. Moreover, FIG. 18 at 1818, 1824, 1830, and 1836 and FIG. 19 at 1908 show that the indication of the set of measurements may be transmitted for the LMF 1812.

In one aspect, the assistance data, the request to perform the set of measurements, the indication that the UE supports the first type of WiFi-based positioning, and the indication of the set of measurements may be associated with LPP signaling. For example, the assistance data received at 2006, the request received at 2010, the indication of support for the first type of WiFi-based positioning transmitted at 2008, and the indication of the set of measurements transmitted at 2014 may be associated with LPP signaling.

In one aspect, at 2204, the UE may transmit or receive the LPP signaling associated with the at least one WLAN AP based on the assistance data, the request to perform the set of measurements, the indication that the UE supports the first type of WiFi-based positioning, and the indication of the set of measurements being associated with the LPP signaling. For example, FIG. 20 at 2007 shows that the UE 2002 may transmit or receive LPP signaling, and the request received at 2010, the indication of support transmitted at 2008, and the indication of the set of measurements transmitted at 2014 may be associated with the LPP signaling. In an example, 2204 may be performed by the WiFi positioning component 198.

In one aspect, outputting the indication of the set of performed measurements for the first type of WiFi-based positioning may include: transmitting, for a network entity, the indication of the set of performed measurements for the first type of WiFi-based positioning. For example, FIG. 20 at 2014 shows that the UE 2002 may transmit, for the network entity 2004, the indication of the set of measurements performed at 2012.

In one aspect, outputting the indication of the set of performed measurements for the first type of WiFi-based positioning may include: storing, in a memory or a cache, the indication of the set of performed measurements for the first type of WiFi-based positioning. For example, outputting the indication of the set of performed measurements at 2014 may include storing the indication of the set of performed measurements in a memory or a cache.

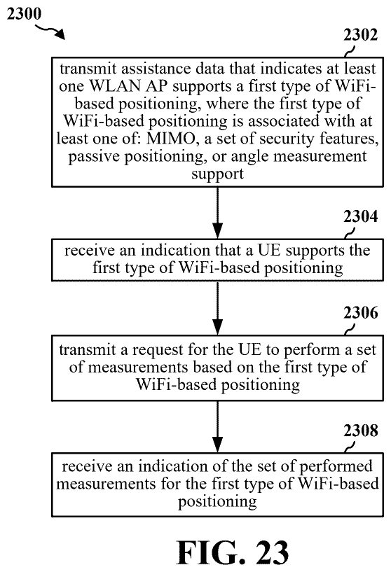

FIG. 23 is a flowchart 2300 of a method of wireless communication. The method may be performed by a network entity (e.g., the core network 120, the LMF 166, the LMF 606, the positioning server 1328, the server 1410, the LMF 1418, the LMF 1812, the network entity 2004). The method may be associated with various advantages at the network entity, such as facilitating 802.11az based positioning. In an example, the method may be performed by the WiFi positioning component 199.

At 2302, the network entity transmits assistance data that indicates at least one WLAN AP supports a first type of WiFi-based positioning, where the first type of WiFi-based positioning is associated with at least one of: MIMO, a set of security features, passive positioning, or angle measurement support. For example, FIG. 20 at 2006 shows that the network entity 2004 may transmit assistance data that indicates that at least one WLAN AP supports a first type of WiFi-based positioning, where the first type of WiFi-based positioning is associated with at least one of: MIMO, a set of security features, passive positioning, or angle measurement support. In an example, MIMO may correspond to the MIMO support 804 and/or the MU support 810 described above, the set of security features may correspond to the MAC security support 806 and/or the PHY security support 808 described above, the passive positioning may correspond to the passive ranging support 812 described above, and the angle measurement support may correspond to the AoA/AoD support 814 described above. Passive positioning may include aspects described above in the description of FIGS. 9-11. Angle measurement support may include aspects described above in the description of FIG. 12. In an example, the assistance data may be or include the assistance data 1316, the LPP assistance data described in the second example 1404 and/or the third example 1406 of FIG. 14, the WLAN assistance data 1502, and/or the WLAN assistance data illustrated in FIG. 16. In an example, the at least one WLAN AP may be or include the WLAN AP(s) 1302. In an example, 2302 may be performed by the WiFi positioning component 199.

At 2304, the network entity receives an indication that a UE supports the first type of WiFi-based positioning. For example, FIG. 20 at 2008 shows that the network entity 2004 may receive an indication that the UE 2002 supports the first type of WiFi-based positioning. In an example, the indication that the UE supports the first type of WiFi-based positioning may correspond to the transmissions of the UE at 1814, 1820, 1826, 1832, or 1904. In an example, 2304 may be performed by the WiFi positioning component 199.

At 2306, the network entity transmits a request for the UE to perform a set of measurements based on the first type of WiFi-based positioning. For example, FIG. 20 at 2010 shows that the network entity 2004 may transmit a request to perform a set of measurements based on the first type of WiFi-based positioning. In an example, the request may correspond to the transmissions of the LMF 1812 at 1816, 1822, 1828, 1834, and/or 1906. In an example, 2306 may be performed by the WiFi positioning component 199.

At 2308, the network entity receives an indication of the set of performed measurements for the first type of WiFi-based positioning. For example, FIG. 20 at 2014 shows that the network entity 2004 may receive an indication of a set of performed measurements for the first type of WiFi-based positioning. In an example, the indication of the set of performed measurements may correspond to the transmissions of the UE 1810 at 1818, 1824, 1830, 1836, and/or 1908. In an example, 2308 may be performed by the WiFi positioning component 199.

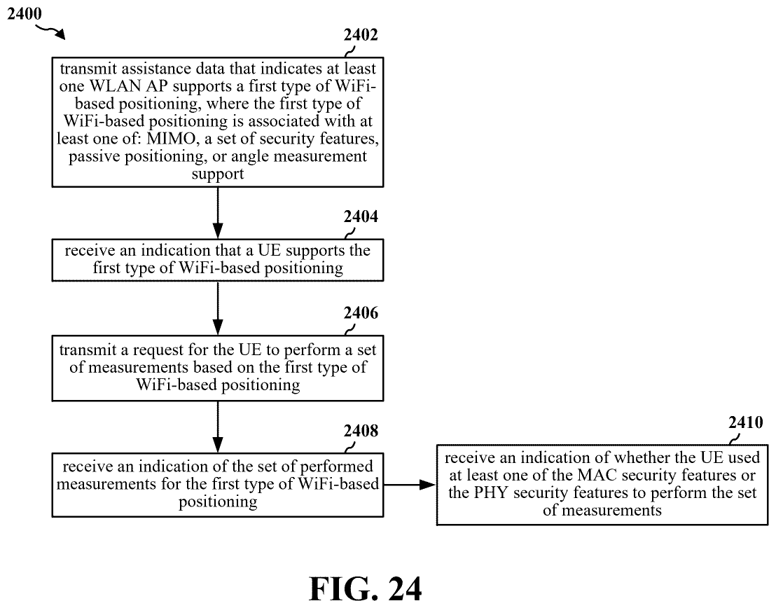

FIG. 24 is a flowchart 2400 of a method of wireless communication. The method may be performed by a network entity (e.g., the core network 120, the LMF 166, the LMF 606, the positioning server 1328, the server 1410, the LMF 1418, the LMF 1812, the network entity 2004). The method may be associated with various advantages at the network entity, such as facilitating 802.11az based positioning. In an example, the method (including the various aspects detailed below) may be performed by the WiFi positioning component 199.

At 2402, the network entity transmits assistance data that indicates at least one WLAN AP supports a first type of WiFi-based positioning, where the first type of WiFi-based positioning is associated with at least one of: MIMO, a set of security features, passive positioning, or angle measurement support. For example, FIG. 20 at 2006 shows that the network entity 2004 may transmit assistance data that indicates that at least one WLAN AP supports a first type of WiFi-based positioning, where the first type of WiFi-based positioning is associated with at least one of: MIMO, a set of security features, passive positioning, or angle measurement support. In an example, MIMO may correspond to the MIMO support 804 and/or the MU support 810 described above, the set of security features may correspond to the MAC security support 806 and/or the PHY security support 808 described above, the passive positioning may correspond to the passive ranging support 812 described above, and the angle measurement support may correspond to the AoA/AoD support 814 described above. Passive positioning may include aspects described above in the description of FIGS. 9-11. Angle measurement support may include aspects described above in the description of FIG. 12. In an example, the assistance data may be or include the assistance data 1316, the LPP assistance data described in the second example 1404 and/or the third example 1406 of FIG. 14, the WLAN assistance data 1502, and/or the WLAN assistance data illustrated in FIG. 16. In an example, the at least one WLAN AP may be or include the WLAN AP(s) 1302. In an example, 2402 may be performed by the WiFi positioning component 199.

At 2404, the network entity receives an indication that a UE supports the first type of WiFi-based positioning. For example, FIG. 20 at 2008 shows that the network entity 2004 may receive an indication that the UE 2002 supports the first type of WiFi-based positioning. In an example, the indication that the UE supports the first type of WiFi-based positioning may correspond to the transmissions of the UE at 1814, 1820, 1826, 1832, or 1904. In an example, 2404 may be performed by the WiFi positioning component 199.

At 2406, the network entity transmits a request for the UE to perform a set of measurements based on the first type of WiFi-based positioning. For example, FIG. 20 at 2010 shows that the network entity 2004 may transmit a request to perform a set of measurements based on the first type of WiFi-based positioning. In an example, the request may correspond to the transmissions of the LMF 1812 at 1816, 1822, 1828, 1834, and/or 1906. In an example, 2406 may be performed by the WiFi positioning component 199.

At 2408, the network entity receives an indication of the set of performed measurements for the first type of WiFi-based positioning. For example, FIG. 20 at 2014 shows that the network entity 2004 may receive an indication of a set of performed measurements for the first type of WiFi-based positioning. In an example, the indication of the set of performed measurements may correspond to the transmissions of the UE 1810 at 1818, 1824, 1830, 1836, and/or 1908. In an example, 2408 may be performed by the WiFi positioning component 199.

In one aspect, the first type of WiFi-based positioning may be associated with 802.11az-based positioning. In an example, the first type of WiFi-based positioning may support the 802.11-az features 802. In another example, 802.11az-based positioning may be associated with aspects described above in the description of FIG. 17.

In one aspect, the assistance data may include a WLAN assistance data element, and the assistance data may include a supported channels field that indicates that the at least one WLAN AP supports 802.11az-based channels for the 802.11az-based positioning. For example, the assistance data may be the WLAN assistance data 1502 and the supported channels field may be or include the 11az supported channels field 1510.

In one aspect, the first type of WiFi-based positioning may be associated with the angle measurement support, where the indication that the UE supports the first type of WiFi-based positioning may indicate that the UE is capable of reporting one or more of at least one AoA or at least one AoD of at least one signal transmitted by the at least one AP, where the at least one AoD may correspond to the at least one AP, where the request to perform the set of measurements may indicate that the UE is to measure the one or more of the at least one AoA or the at least one AoD of the at least one signal, and where the indication of the set of measurements for the first type of WiFi-based positioning may include one or more of at least one AoA measurement or at least one AoD measurement of the at least one signal. For example, the aforementioned aspect may correspond to the first example 1802 of FIG. 18.

In one aspect, the set of measurements may have one of: a first reporting granularity corresponding to the first type of WiFi-based positioning, or a second reporting granularity corresponding to a second type of WiFi-based positioning. For example, the set of measurements received at 2014 may include a first reporting granularity corresponding to the first type of WiFi-based positioning, or a second reporting granularity corresponding to a second type of WiFi-based positioning.

In one aspect, the first type of WiFi-based positioning may be associated with the MIMO, where the indication that the UE supports the first type of WiFi-based positioning may indicate that the UE is capable of MIMO-based positioning, where the request to perform the set of measurements may indicate one or more of: the UE is requested to perform the set of measurements using the MIMO or the UE is to report a number of spatial streams associated with the set of measurements, and where the indication of the set of measurements for the first type of WiFi-based positioning may include one or more of an indication of whether the UE used the MIMO to perform the set of measurements or an indication of the number of spatial streams. For example, the aforementioned aspect may correspond to the second example 1804 of FIG. 18.

In one aspect, the indication that the UE supports the first type of WiFi-based positioning may indicate that the UE supports a first RTT reporting granularity and a second RTT reporting granularity that is greater than the first RTT reporting granularity, where the request to perform the set of measurements may indicate that the UE is requested to perform the set of measurements using the first RTT reporting granularity, and where the indication of the set of measurements may indicate whether the UE performed the set of measurements using the first RTT reporting granularity. For example, the aforementioned aspect may correspond to the third example 1806 of FIG. 18.

In one aspect, the indication that the UE supports the first type of WiFi-based positioning may indicate that the UE supports the set of security features, where the set of security features may include at least one of MAC security features or PHY security features for the first type of WiFi-based positioning, where the request to perform the set of measurements may indicate that the UE is requested to perform the set of measurements using at least one of the MAC security features or the PHY security features. For example, the aforementioned aspect may correspond to the fourth example 1808 of FIG. 18. Furthermore, the fourth example 1808 of FIG. 18 shows that the set of security features may include MAC security features and/or PHY security features for the first type of WiFi-based positioning.

In one aspect, at 2410, the network entity may receive an indication of whether the UE used at least one of the MAC security features or the PHY security features to perform the set of measurements. For example, FIG. 18 at 1836 shows that the LMF 1812 may receive an indication of whether the UE 1810 used at least one of the MAC security features or the PHY security features to perform the set of measurements. In an example, 2410 may be performed by the WiFi positioning component 198.

In one aspect, the first type of WiFi-based positioning may be associated with the passive positioning, where the request to perform the set of measurements may indicate that the UE is requested to perform the passive positioning, and where the set of measurements may include a set of timing measurements for the passive positioning. For example, the aforementioned aspect may correspond to the example 1902 of FIG. 19.

In one aspect, the request to perform the set of measurements may further indicate one or more of the at least one WLAN AP that are to be utilized for the passive positioning. For example, the request transmitted by the network entity 2004 at 2010 may indicate one or more of the WLAN AP(s) 1302.

In one aspect, the assistance data may be transmitted by a LMF of the network entity, where the request to perform the set of measurements may be transmitted from the LMF of the network entity, and where the indication that the UE supports the first type of WiFi-based positioning and the indication of the set of measurements may be received by the LMF of the network entity. For example, the second example 1404 and the third example 1406 of FIG. 14 shows that the server 1410 and/or the LMF 1418 may transmit LPP assistance data. Furthermore, FIG. 18 at 1816, 1822, 1828, and 1834 and FIG. 19 at 1906 show that the request to perform the set of measurements may be transmitted by the LMF 1812. Additionally, FIG. 18 at 1814, 1820, 1826, and 1832 and FIG. 19 at 1904 show that the indication that the UE supports the first type of WiFi-based positioning may be received by the LMF 1812. Moreover, FIG. 18 at 1818, 1824, 1830, and 1836 and FIG. 19 at 1908 show that the indication of the set of measurements may be received by the LMF 1812.

In one aspect, the assistance data, the request to perform the set of measurements, the indication that the UE supports the first type of WiFi-based positioning, and the indication of the set of measurements may be associated with LPP signaling. For example, the assistance data transmitted at 2006, the request transmitted at 2010, the indication of support for the first type of WiFi-based positioning received at 2008, and the indication of the set of measurements received at 2014 may be associated with LPP signaling.

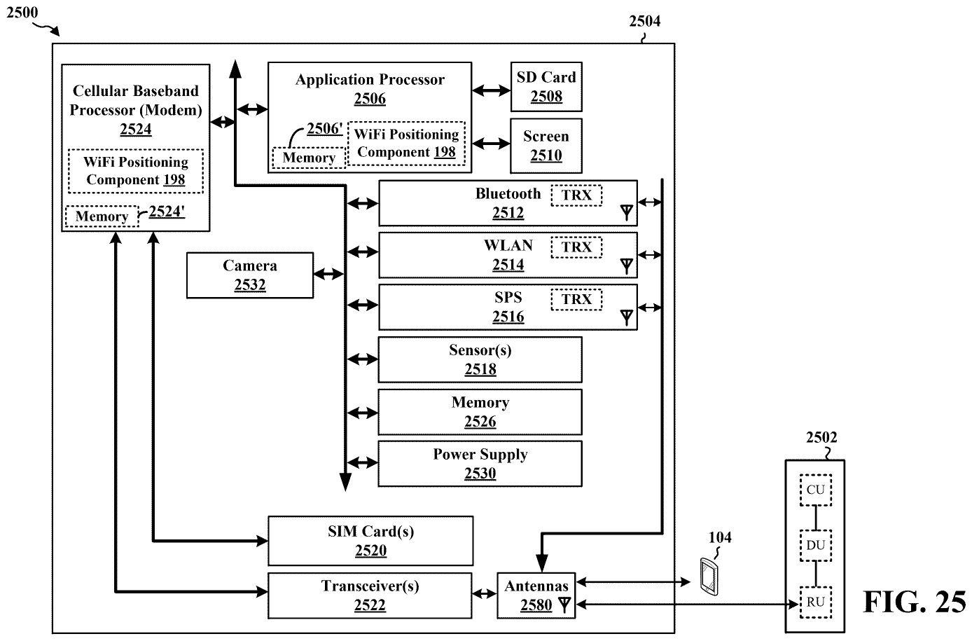

FIG. 25 is a diagram 2500 illustrating an example of a hardware implementation for an apparatus 2504. The apparatus 2504 may be a UE, a component of a UE, or may implement UE functionality. In some aspects, the apparatus 2504 may include a cellular baseband processor 2524 (also referred to as a modem) coupled to one or more transceivers 2522 (e.g., cellular RF transceiver). The cellular baseband processor 2524 may include on-chip memory 2524′. In some aspects, the apparatus 2504 may further include one or more subscriber identity modules (SIM) cards 2520 and an application processor 2506 coupled to a secure digital (SD) card 2508 and a screen 2510. The application processor 2506 may include on-chip memory 2506′. In some aspects, the apparatus 2504 may further include a Bluetooth module 2512, a WLAN module 2514, an SPS module 2516 (e.g., GNSS module), one or more sensor modules 2518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2526, a power supply 2530, and/or a camera 2532. The Bluetooth module 2512, the WLAN module 2514, and the SPS module 2516 may include an on-chip transceiver (TRX) (or in some cases, just a receiver (RX)). The Bluetooth module 2512, the WLAN module 2514, and the SPS module 2516 may include their own dedicated antennas and/or utilize the antennas 2580 for communication. The cellular baseband processor 2524 communicates through the transceiver(s) 2522 via one or more antennas 2580 with the UE 104 and/or with an RU associated with a network entity 2502. The cellular baseband processor 2524 and the application processor 2506 may each include a computer-readable medium/memory 2524′, 2506′, respectively. The additional memory modules 2526 may also be considered a computer-readable medium/memory. Each computer-readable medium/memory 2524′, 2506′, 2526 may be non-transitory. The cellular baseband processor 2524 and the application processor 2506 are each responsible for general processing, including the execution of software stored on the computer-readable medium/memory. The software, when executed by the cellular baseband processor 2524/application processor 2506, causes the cellular baseband processor 2524/application processor 2506 to perform the various functions described supra. The computer-readable medium/memory may also be used for storing data that is manipulated by the cellular baseband processor 2524/application processor 2506 when executing software. The cellular baseband processor 2524/application processor 2506 may be a component of the UE 350 and may include the memory 360 and/or at least one of the TX processor 368, the RX processor 356, and the controller/processor 359. In one configuration, the apparatus 2504 may be a processor chip (modem and/or application) and include just the cellular baseband processor 2524 and/or the application processor 2506, and in another configuration, the apparatus 2504 may be the entire UE (e.g., see UE 350 of FIG. 3) and include the additional modules of the apparatus 2504.

As discussed supra, the WiFi positioning component 198 may be configured to obtain assistance data that indicates at least one WLAN AP supports a first type of WiFi-based positioning, where the first type of WiFi-based positioning is associated with at least one of: MIMO, a set of security features, passive positioning, or angle measurement support. The WiFi positioning component 198 may be configured to transmit an indication that the UE supports the first type of WiFi-based positioning. The WiFi positioning component 198 may be configured to receive a request to perform a set of measurements based on the first type of WiFi-based positioning. The WiFi positioning component 198 may be configured to perform, based on the request, the set of measurements for the first type of WiFi-based positioning. The WiFi positioning component 198 may be configured to output an indication of the set of performed measurements for the first type of WiFi-based positioning. The WiFi positioning component 198 may be configured to transmit an indication of whether the UE used at least one of the MAC security features or the PHY security features to perform the set of measurements. The WiFi positioning component 198 may be configured to transmit or receive the LPP signaling associated with the at least one WLAN AP based on the assistance data, the request to perform the set of measurements, the indication that the UE supports the first type of WiFi-based positioning, and the indication of the set of measurements being associated with the LPP signaling. The WiFi positioning component 198 may be within the cellular baseband processor 2524, the application processor 2506, or both the cellular baseband processor 2524 and the application processor 2506. The WiFi positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2504 may include a variety of components configured for various functions. In one configuration, the apparatus 2504, and in particular the cellular baseband processor 2524 and/or the application processor 2506, may include means for obtaining assistance data that indicates at least one WLAN AP supports a first type of WiFi-based positioning, where the first type of WiFi-based positioning is associated with at least one of: MIMO, a set of security features, passive positioning, or angle measurement support. In one configuration, the apparatus 2504, and in particular the cellular baseband processor 2524 and/or the application processor 2506, may include means for transmitting an indication that the UE supports the first type of WiFi-based positioning. In one configuration, the apparatus 2504, and in particular the cellular baseband processor 2524 and/or the application processor 2506, may include means for receiving a request to perform a set of measurements based on the first type of WiFi-based positioning. In one configuration, the apparatus 2504, and in particular the cellular baseband processor 2524 and/or the application processor 2506, may include means for performing, based on the request, the set of measurements for the first type of WiFi-based positioning. In one configuration, the apparatus 2504, and in particular the cellular baseband processor 2524 and/or the application processor 2506, may include means for outputting an indication of the set of performed measurements for the first type of WiFi-based positioning. In one configuration, the apparatus 2504, and in particular the cellular baseband processor 2524 and/or the application processor 2506, may include means for transmitting an indication of whether the UE used at least one of the MAC security features or the PHY security features to perform the set of measurements. In one configuration, the apparatus 2504, and in particular the cellular baseband processor 2524 and/or the application processor 2506, may include means for transmitting or receiving the LPP signaling associated with the at least one WLAN AP based on the assistance data, the request to perform the set of measurements, the indication that the UE supports the first type of WiFi-based positioning, and the indication of the set of measurements being associated with the LPP signaling. The means may be the WiFi positioning component 198 of the apparatus 2504 configured to perform the functions recited by the means. As described supra, the apparatus 2504 may include the TX processor 368, the RX processor 356, and the controller/processor 359. As such, in one configuration, the means may be the TX processor 368, the RX processor 356, and/or the controller/processor 359 configured to perform the functions recited by the means.

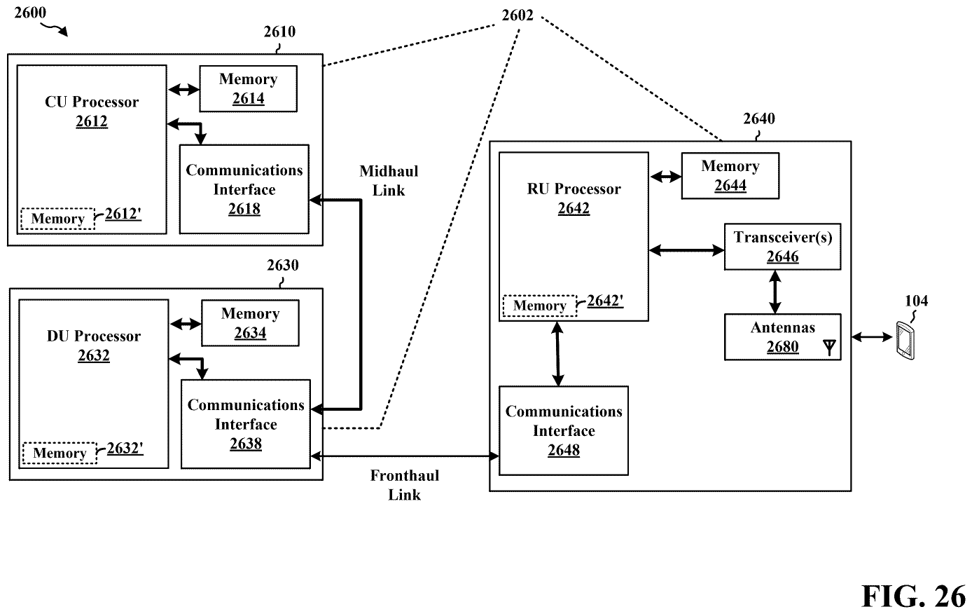

FIG. 26 is a diagram 2600 illustrating an example of a hardware implementation for a network entity 2602. The network entity 2602 may be a BS, a component of a BS, or may implement BS functionality. The network entity 2602 may include at least one of a CU 2610, a DU 2630, or an RU 2640. For example, the network entity 2602 may include the CU 2610; both the CU 2610 and the DU 2630; each of the CU 2610, the DU 2630, and the RU 2640; the DU 2630; both the DU 2630 and the RU 2640; or the RU 2640. The CU 2610 may include a CU processor 2612. The CU processor 2612 may include on-chip memory 2612′. In some aspects, the CU 2610 may further include additional memory modules 2614 and a communications interface 2618. The CU 2610 communicates with the DU 2630 through a midhaul link, such as an F1 interface. The DU 2630 may include a DU processor 2632. The DU processor 2632 may include on-chip memory 2632′. In some aspects, the DU 2630 may further include additional memory modules 2634 and a communications interface 2638. The DU 2630 communicates with the RU 2640 through a fronthaul link. The RU 2640 may include an RU processor 2642. The RU processor 2642 may include on-chip memory 2642′. In some aspects, the RU 2640 may further include additional memory modules 2644, one or more transceivers 2646, antennas 2680, and a communications interface 2648. The RU 2640 communicates with the UE 104. The on-chip memory 2612′, 2632′, 2642′ and the additional memory modules 2614, 2634, 2644 may each be considered a computer-readable medium/memory. Each computer-readable medium/memory may be non-transitory. Each of the processors 2612, 2632, 2642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

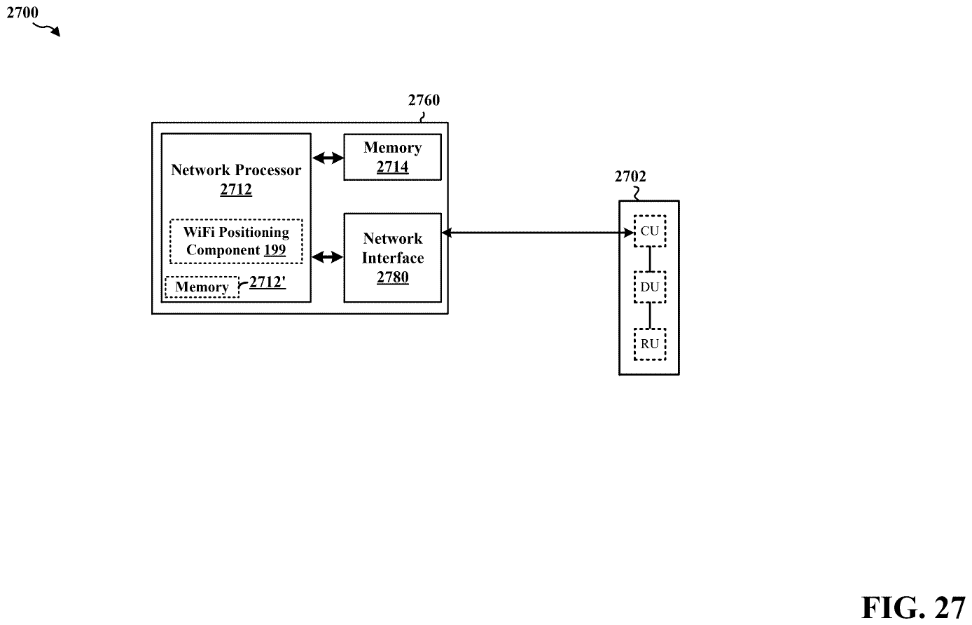

FIG. 27 is a diagram 2700 illustrating an example of a hardware implementation for a network entity 2760. In one example, the network entity 2760 may be within the core network 120. The network entity 2760 may include a network processor 2712. The network processor 2712 may include on-chip memory 2712′. In some aspects, the network entity 2760 may further include additional memory modules 2714. The network entity 2760 communicates via the network interface 2780 directly (e.g., backhaul link) or indirectly (e.g., through a RIC) with the CU 2702. The on-chip memory 2712′ and the additional memory modules 2714 may each be considered a computer-readable medium/memory. Each computer-readable medium/memory may be non-transitory. The processor 2712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the WiFi positioning component 199 may be configured to transmit assistance data that indicates at least one WLAN AP supports a first type of WiFi-based positioning, where the first type of WiFi-based positioning is associated with at least one of: MIMO, a set of security features, passive positioning, or angle measurement support. The WiFi positioning component 199 may be configured to receive an indication that a UE supports the first type of WiFi-based positioning. The WiFi positioning component 199 may be configured to transmit a request for the UE to perform a set of measurements based on the first type of WiFi-based positioning. The WiFi positioning component 199 may be configured to receive an indication of the set of performed measurements for the first type of WiFi-based positioning. The WiFi positioning component 199 may be configured to receive an indication of whether the UE used at least one of the MAC security features or the PHY security features to perform the set of measurements. The WiFi positioning component 199 The WiFi positioning component 199 may be within the processor 2712. The WiFi positioning component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2760 may include a variety of components configured for various functions. In one configuration, the network entity 2760 may include means for transmitting assistance data that indicates at least one WLAN AP supports a first type of WiFi-based positioning, where the first type of WiFi-based positioning is associated with at least one of: MIMO, a set of security features, passive positioning, or angle measurement support. In one configuration, the network entity 2760 may include means for receiving an indication that a UE supports the first type of WiFi-based positioning. In one configuration, the network entity 2760 may include means for transmitting a request for the UE to perform a set of measurements based on the first type of WiFi-based positioning. In one configuration, the network entity 2760 may include means for receiving an indication of the set of performed measurements for the first type of WiFi-based positioning. In one configuration, the network entity 2760 may include means for receiving an indication of whether the UE used at least one of the MAC security features or the PHY security features to perform the set of measurements. The means may be the WiFi positioning component 199 of the network entity 2760 configured to perform the functions recited by the means.

As discussed above, 802.11-az based positioning may include support for MIMO, MU-MIMO, AoD/AoA measurements, passive positioning/passive ranging, MAC security, and/or PHY security. Such features may not be supported by other types of positioning technologies, such as positioning technologies that utilize FTM. Furthermore, some types of LPP signaling may not include support for the aforementioned features.

Various technologies pertaining to 801.11az based positioning support for LPP are described herein. In an example, a UE obtains assistance data that indicates at least one WLAN AP supports a first type of WiFi-based positioning, where the first type of WiFi-based positioning is associated with at least one of: MIMO, a set of security features, passive positioning, or angle measurement support. The UE transmits an indication that the UE supports the first type of WiFi-based positioning. The UE receives a request to perform a set of measurements based on the first type of WiFi-based positioning. The UE performs, based on the request, the set of measurements for the first type of WiFi-based positioning. The UE outputs an indication of the set of performed measurements for the first type of WiFi-based positioning. Vis-à-vis the aforementioned technologies, the UE may be informed that the at least one WLAN AP supports the first type of WiFi-based positioning (e.g., 802.11-az based positioning). The UE may then perform the set of measurements using the first type of WiFi-based positioning. Thus, the aforementioned technologies may facilitate a more accurate location determination of the UE in comparison to other types of WiFi-based positioning.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: obtaining assistance data that indicates at least one wireless local-area network (WLAN) access point (AP) supports a first type of WiFi-based positioning, where the first type of WiFi-based positioning is associated with at least one of: multiple input-multiple output (MIMO), a set of security features, passive positioning, or angle measurement support; transmitting an indication that the UE supports the first type of WiFi-based positioning; receiving a request to perform a set of measurements based on the first type of WiFi-based positioning; performing, based on the request, the set of measurements for the first type of WiFi-based positioning; and outputting an indication of the set of performed measurements for the first type of WiFi-based positioning.

Aspect 2 is the method of aspect 1, where the first type of WiFi-based positioning is associated with 802.11az-based positioning.

Aspect 3 is the method of aspect 2, where the assistance data includes a WLAN assistance data element, and where the assistance data includes a supported channels field that indicates that the at least one WLAN AP supports 802.11az-based channels for the 802.11az-based positioning.

Aspect 4 is the method of any of aspects 1-3, where the first type of WiFi-based positioning is associated with the angle measurement support, where the indication that the UE supports the first type of WiFi-based positioning indicates that the UE is capable of reporting one or more of at least one angle of arrival (AoA) or at least one angle of departure (AoD) of at least one signal transmitted by the at least one WLAN AP, where the at least one AoD corresponds to the at least one WLAN AP, where the request to perform the set of measurements indicates that the UE is to measure one or more of the at least one AoA or the at least one AoD of the at least one signal, and where the indication of the set of measurements for the first type of WiFi-based positioning includes one or more of at least one AoA measurement or at least one AoD measurement of the at least one signal.

Aspect 5 is the method of aspect 4, where the set of measurements includes one of: a first reporting granularity corresponding to the first type of WiFi-based positioning, or a second reporting granularity corresponding to a second type of WiFi-based positioning.

Aspect 6 is the method of any of aspects 1-5, where the first type of WiFi-based positioning is associated with the MIMO, where the indication that the UE supports the first type of WiFi-based positioning indicates that the UE is capable of MIMO-based positioning, where the request to perform the set of measurements indicates one or more of: the UE is requested to perform the set of measurements using the MIMO or the UE is to report a number of spatial streams associated with the set of measurements, and where the indication of the set of measurements for the first type of WiFi-based positioning includes one or more of an indication of whether the UE used the MIMO to perform the set of measurements or an indication of the number of spatial streams.

Aspect 7 is the method of any of aspects 1-6, where the indication that the UE supports the first type of WiFi-based positioning indicates that the UE supports a first round trip time (RTT) reporting granularity and a second RTT reporting granularity that is greater than the first RTT reporting granularity, where the request to perform the set of measurements indicates that the UE is requested to perform the set of measurements using the first RTT reporting granularity, and where the indication of the set of measurements indicates whether the UE performed the set of measurements using the first RTT reporting granularity.

Aspect 8 is the method of any of aspects 1-7, where the indication that the UE supports the first type of WiFi-based positioning indicates that the UE supports the set of security features, where the set of security features includes at least one of medium access control (MAC) security features or physical (PHY) security features for the first type of WiFi-based positioning, where the request to perform the set of measurements indicates that the UE is requested to perform the set of measurements using at least one of the MAC security features or the PHY security features.

Aspect 9 is the method of aspect 8, further including: transmitting an indication of whether the UE used at least one of the MAC security features or the PHY security features to perform the set of measurements.

Aspect 10 is the method of any of aspects 1-9, where the first type of WiFi-based positioning is associated with the passive positioning, where the request to perform the set of measurements indicates that the UE is requested to perform the passive positioning, and where the set of measurements includes a set of timing measurements for the passive positioning.

Aspect 11 is the method of aspect 10, where the request to perform the set of measurements further indicates one or more of the at least one WLAN AP that are to be utilized for the passive positioning.

Aspect 12 is the method of any of aspects 1-11, where the assistance data is obtained from a location management function (LMF) of a network entity, where the request to perform the set of measurements is received from the LMF of the network entity, and where the indication that the UE supports the first type of WiFi-based positioning and the indication of the set of measurements are transmitted for the LMF of the network entity.

Aspect 13 is the method of any of aspects 1-12, where the assistance data, the request to perform the set of measurements, the indication that the UE supports the first type of WiFi-based positioning, and the indication of the set of measurements are associated with long-term evolution (LTE) positioning protocol (LPP) signaling.

Aspect 14 is the method of aspect 13, further including: transmitting or receiving the LPP signaling associated with the at least one WLAN AP based on the assistance data, the request to perform the set of measurements, the indication that the UE supports the first type of WiFi-based positioning, and the indication of the set of measurements being associated with the LPP signaling.

Aspect 15 is the method of any of aspects 1-14, where outputting the indication of the set of performed measurements for the first type of WiFi-based positioning includes: transmitting, for a network entity, the indication of the set of performed measurements for the first type of WiFi-based positioning.

Aspect 16 is the method of any of aspects 1-15, where outputting the indication of the set of performed measurements for the first type of WiFi-based positioning includes: storing, in a memory or a cache, the indication of the set of performed measurements for the first type of WiFi-based positioning.

Aspect 17 is an apparatus for wireless communication at a UE including a memory and at least one processor coupled to the memory and based at least in part on information stored in the memory, the at least one processor is configured to perform a method in accordance with any of aspects 1-16.

Aspect 18 is an apparatus for wireless communications, including means for performing a method in accordance with any of aspects 1-16.

Aspect 19 is the apparatus of aspect 17 or 18 further including at least one of a transceiver or an antenna coupled to the at least one processor, where the at least one processor is configured to transmit the indication that the UE supports the first type of WiFi-based positioning via at least one of the transceiver or the antenna.

Aspect 20 is a computer-readable medium (e.g., a non-transitory computer-readable medium) including instructions that, when executed by at least one processor, cause the at least one processor to perform a method in accordance with any of aspects 1-16.

Aspect 21 is a method of wireless communication at a network entity, including: transmitting assistance data that indicates at least one wireless local-area network (WLAN) access point (AP) supports a first type of WiFi-based positioning, where the first type of WiFi-based positioning is associated with at least one of: multiple input-multiple output (MIMO), a set of security features, passive positioning, or angle measurement support; receiving an indication that a user equipment (UE) supports the first type of WiFi-based positioning; transmitting a request for the UE to perform a set of measurements based on the first type of WiFi-based positioning; and receiving an indication of the set of performed measurements for the first type of WiFi-based positioning.

Aspect 22 is the method of aspect 21, where the first type of WiFi-based positioning is associated with 802.11az-based positioning.

Aspect 23 is the method of aspect 22, where the assistance data includes a WLAN assistance data element, and where the assistance data includes a supported channels field that indicates that the at least one WLAN AP supports 802.11az-based channels for the 802.11az-based positioning.

Aspect 24 is the method of any of aspects 21-23, where the first type of WiFi-based positioning is associated with the angle measurement support, where the indication that the UE supports the first type of WiFi-based positioning indicates that the UE is capable of reporting one or more of at least one angle of arrival (AoA) or at least one angle of departure (AoD) of at least one signal transmitted by the at least one WLAN AP, where the at least one AoD corresponds to the at least one WLAN AP, where the request to perform the set of measurements indicates that the UE is to measure one or more of the at least one AoA or the at least one AoD of the at least one signal, and where the indication of the set of measurements for the first type of WiFi-based positioning includes one or more of at least one AoA measurement or at least one AoD measurement of the at least one signal.

Aspect 25 is the method of aspect 24, where the set of measurements has one of: a first reporting granularity corresponding to the first type of WiFi-based positioning, or a second reporting granularity corresponding to a second type of WiFi-based positioning.

Aspect 26 is the method of any of aspects 21-25, where the first type of WiFi-based positioning is associated with the MIMO, where the indication that the UE supports the first type of WiFi-based positioning indicates that the UE is capable of MIMO-based positioning, where the request to perform the set of measurements indicates one or more of: the UE is requested to perform the set of measurements using the MIMO or the UE is to report a number of spatial streams associated with the set of measurements, and where the indication of the set of measurements for the first type of WiFi-based positioning includes one or more of an indication of whether the UE used the MIMO to perform the set of measurements or an indication of the number of spatial streams.

Aspect 27 is the method of any of aspects 21-26, where the indication that the UE supports the first type of WiFi-based positioning indicates that the UE supports a first round trip time (RTT) reporting granularity and a second RTT reporting granularity that is greater than the first RTT reporting granularity, where the request to perform the set of measurements indicates that the UE is requested to perform the set of measurements using the first RTT reporting granularity, and where the indication of the set of measurements indicates whether the UE performed the set of measurements using the first RTT reporting granularity.

Aspect 28 is the method of any of aspects 21-27, where the indication that the UE supports the first type of WiFi-based positioning indicates that the UE supports the set of security features, where the set of security features includes at least one of medium access control (MAC) security features or physical (PHY) security features for the first type of WiFi-based positioning, where the request to perform the set of measurements indicates that the UE is requested to perform the set of measurements using at least one of the MAC security features or the PHY security features.

Aspect 29 is the method of aspect 28, further including: receiving an indication of whether the UE used at least one of the MAC security features or the PHY security features to perform the set of measurements.

Aspect 30 is the method of any of aspects 21-29, where the first type of WiFi-based positioning is associated with the passive positioning, where the request to perform the set of measurements indicates that the UE is requested to perform the passive positioning, and where the set of measurements includes a set of timing measurements for the passive positioning.

Aspect 31 is the method of aspect 30, where the request to perform the set of measurements further indicates one or more of the at least one WLAN AP that are to be utilized for the passive positioning.

Aspect 32 is the method of any of aspects 21-31, where the assistance data is transmitted by a location management function (LMF) of the network entity, where the request to perform the set of measurements is transmitted from the LMF of the network entity, and where the indication that the UE supports the first type of WiFi-based positioning and the indication of the set of measurements are received by the LMF of the network entity.

Aspect 33 is the method of any of aspects 21-32, where the assistance data, the request to perform the set of measurements, the indication that the UE supports the first type of WiFi-based positioning, and the indication of the set of measurements are associated with long-term evolution (LTE) positioning protocol (LPP) signaling.

Aspect 34 is an apparatus for wireless communication at a network entity including a memory and at least one processor coupled to the memory and based at least in part on information stored in the memory, the at least one processor is configured to perform a method in accordance with any of aspects 21-33.

Aspect 35 is an apparatus for wireless communications, including means for performing a method in accordance with any of aspects 21-33.

Aspect 36 is the apparatus of aspect 34 or 35 further including at least one of a transceiver or an antenna coupled to the at least one processor, where the at least one processor is configured to receive the indication that the UE supports the first type of WiFi-based positioning via at least one of the transceiver or the antenna.

Aspect 37 is a computer-readable medium (e.g., a non-transitory computer-readable medium) including instructions that, when executed by at least one processor, cause the at least one processor to perform a method in accordance with any of aspects 21-33.

1. An apparatus for wireless communication at a user equipment (UE), comprising:
a memory; and
at least one processor coupled to the memory and, based at least in part on information stored in the memory, the at least one processor is configured to:
obtain assistance data that indicates at least one wireless local-area network (WLAN) access point (AP) supports a first type of WiFi-based positioning, wherein the first type of WiFi-based positioning is associated with at least one of: multiple input-multiple output (MIMO), a set of security features, passive positioning, or angle measurement support;
transmit an indication that the UE supports the first type of WiFi-based positioning; receive a request to perform a set of measurements based on the first type of WiFi-based positioning;
perform, based on the request, the set of measurements for the first type of WiFi-based positioning; and
output an indication of the set of performed measurements for the first type of WiFi-based positioning.

2. The apparatus of claim 1, wherein the first type of WiFi-based positioning is associated with 802.11 az-based positioning.

3. The apparatus of claim 2, wherein the assistance data comprises a WLAN assistance data element, and wherein the assistance data includes a supported channels field that indicates that the at least one WLAN AP supports 802.11 az-based channels for the 802.11 az-based positioning.

4. The apparatus of claim 1, wherein the first type of WiFi-based positioning is associated with the angle measurement support, wherein the indication that the UE supports the first type of WiFi-based positioning indicates that the UE is capable of reporting one or more of at least one angle of arrival (AoA) or at least one angle of departure (AoD) of at least one signal transmitted by the at least one WLAN AP, wherein the at least one AoD corresponds to the at least one WLAN AP, wherein the request to perform the set of measurements indicates that the IE is to measure one or more of the at least one AoA or the at least one AoD of the at least one signal, and wherein the indication of the set of measurements for the first type of WiFi-based positioning includes one or more of at least one AoA measurement or at least one AoD measurement of the at least one signal.

5. The apparatus of claim 4, wherein the set of measurements includes one of:
a first reporting granularity corresponding to the first type of WiFi-based positioning, or
a second reporting granularity corresponding to a second type of WiFi-based positioning.

6. The apparatus of claim 1, wherein the first type of WiFi-based positioning is associated with the MIMO, wherein the indication that the UE supports the first type of WiFi-based positioning indicates that the t is capable of MIMO-based positioning, wherein the request to perform the set of measurements indicates one or more of: the UE is requested to perform the set of measurements using the MI MO or the UE is to report a number of spatial streams associated with the set of measurements, and wherein the indication of the set of measurements for the first type of WiFi-based positioning includes one or more of an indication of whether the UE used the MIMO to perform the set of measurements or an indication of the number of spatial streams.

7. The apparatus of claim 1, wherein the indication that the UE supports the first type of WiFi-based positioning indicates that the UE supports a first round trip time (RTT) reporting granularity and a second RTT reporting granularity that is greater than the first RTT reporting granularity, wherein the request to perform the set of measurements indicates that the UE is requested to perform the set of measurements using the first RIT reporting granularity, and wherein the indication of the set of measurements indicates whether the UE performed the set of measurements using the first RTT reporting granularity.

8. The apparatus of claim 1, wherein the indication that the UE supports the first type of WiFi-based positioning indicates that the UE supports the set of security features, wherein the set of security features includes at least one of medium access control (MAC) security features or physical (PHY) security features for the first type of WiFi-based positioning, wherein the request to perform the set of measurements indicates that the UE is requested to perform the set of measurements using at least one of the MAC security features or the PHY security features.

9. The apparatus of claim 8, wherein the at least one processor is further configured to:
transmit an indication of whether the IE used at least one of the MAC security features or the PHY security features to perform the set of measurements.

10. The apparatus of claim 1, wherein the first type of WiFi-based positioning is associated with the passive positioning, wherein the request to perform the set of measurements indicates that the UE is requested to perform the passive positioning, and wherein the set of measurements includes a set of timing measurements for the passive positioning.

11. The apparatus of claim 10, wherein the request to perform the set of measurements further indicates one or more of the at least one WLAN AP that are to be utilized for the passive positioning.

12. The apparatus of claim 1, wherein to obtain the assistance data, the at least one processor is configured to obtain the assistance data from a location management function (LMF) of a network entity, wherein to receive the request to perform the set of measurements, the at least one processor is configured to receive the request to perform the set of measurements from the LMF of the network entity, and wherein to transmit the indication that the UE supports the first type of WiFi-based positioning and to transmit the indication of the set of measurements, the at least one processor is configured to transmit, for the LMF of the network entity, the indication that the UE supports the first type of WiFi-based positioning and the indication of the set of measurements.

13. The apparatus of claim 1, wherein the assistance data, the request to perform the set of measurements, the indication that the UE supports the first type of WiFi-based positioning, and the indication of the set of measurements are associated with long-term evolution (LTE) positioning protocol (LPP) signaling.

14. The apparatus of claim 13, wherein the at least one processor is further configured to:
transmit or receive the LPP signaling associated with the at least one WLAN AP based on the assistance data, the request to perform the set of measurements, the indication that the UE supports the first type of WiFi-based positioning, and the indication of the set of measurements being associated with the LPP signaling.

15. The apparatus of claim 1, wherein to output the indication of the set of performed measurements for the first type of WiFi-based positioning, the at least one processor is configured to: transmit, for a network entity, the indication of the set of performed measurements for the first type of WiFi-based positioning.

16. The apparatus of claim 1, wherein to output the indication of the set of performed measurements for the first type of WiFi-based positioning, the at least one processor is configured to: store, in the memory or a cache, the indication of the set of performed measurements for the first type of WiFi-based positioning.

17. The apparatus of claim 1, further comprising at least one of a transceiver or an antenna coupled to the at least one processor, wherein to transmit the indication that the UE supports the first type of WiFi-based positioning, the at least one processor is configured to transmit the indication that the UE supports the first type of WiFi-based positioning via at least of the transceiver of the antenna.

18. An apparatus for wireless communication at a network entity, comprising:
a memory; and
at least one processor coupled to the memory and, based at least in part on information stored in the memory, the at least one processor is configured to:
transmit assistance data that indicates at least one wireless local-area network (WLAN) access point (AP) supports a first type of WiFi-based
positioning, wherein the first type of WiFi-based positioning is associated with at least one of multiple input-multiple output (IMO), a set of security features, passive positioning, or angle measurement support;
receive an indication that a user equipment (LUE) supports the first type of WiFi-based positioning;
transmit a request for the UE to perform a set of measurements based on the first type of WiFi-based positioning; and
receive an indication of the set of performed measurements for the first type of WiFi-based positioning.

19-28. (canceled)

29. A method of wireless communication at a user equipment (UE), comprising:
obtaining assistance data that indicates at least one wireless local-area network (WLAN) access point (AP) supports a first type of WiFi-based positioning, wherein the first type of WiFi-based positioning is associated with at least one of: multiple input multiple output (MIMO), a set of security features, passive positioning, or angle measurement support;
transmitting an indication that the UE supports the first type of WiFi-based positioning;
receiving a request to perform a set of measurements based on the first type of WiFi-based positioning;
performing, based on the request, the set of measurements for the first type of WiFi-based positioning; and
outputting an indication of the set of performed measurements for the first type of WiFi-based positioning.

30. A method of wireless communication at a network entity, comprising:
transmitting assistance data that indicates at least one wireless local-area network (WLAN) access point (AP) supports a first type of WiFi-based positioning, wherein the first type of WiFi-based positioning is associated with at least one of: multiple input multiple output (MIMO), a set of security features, passive positioning, or angle measurement support;
receiving an indication that a user equipment (UE) supports the first type of WiFi-based positioning;
transmitting a request for the UE to perform a set of measurements based on the first type of WiFi-based positioning; and
receiving an indication of the set of performed measurements for the first type of WiFi-based positioning.
